(19) United States
(12) Patent Application Publication
(10) Pub. No.: US 2026/0239233 A1
(43) Pub. Date: Aug. 13, 2026

(54) TERMINAL, RADIO COMMUNICATION METHOD, AND BASE STATION

(71) Applicant: NTT DOCOMO, INC., Tokyo (JP)

(72) Inventors: Yuki Matsumura, Chiyoda-ku, Tokyo (JP); Satoshi Nagata, Chiyoda-ku, Tokyo (JP); Weiqi Sun, Beijing, Haidian District (CN); Jing Wang, Beijing, Haidian District (CN); Lan Chen, Beijing, Haidian District (CN)

(73) Assignee: NTT DOCOMO, INC., Tokyo (JP)

(21) Appl. No.: 19/156,136

(22) PCT Filed: Feb. 22, 2023
(86) PCT No.: PCT/JP2023/006480

§ 371 Date: Aug. 13, 2025

(51) Int. Cl. H04W 52/36

(52) U.S. Cl. CPC H04W 52/365

(57) ABSTRACT

A terminal according to one aspect of the present disclosure includes a transmitting section that transmits a physical uplink shared channel (PUSCH) by using simultaneous uplink (UL) transmission from multi-panel, and a control section that controls triggering of a power headroom (PHR) based on the PUSCH transmission, based on a specific condition. One aspect of the present disclosure allows transmission power control to be appropriately performed.

### TECHNICAL FIELD

The present disclosure relates to a terminal, a radio communication method, and a base station in next-generation mobile communication systems.

### BACKGROUND ART

In a Universal Mobile Telecommunications System (UMTS) network, the specifications of Long-Term Evolution (LTE) have been drafted for the purpose of further increasing high speed data rates, providing lower latency and so on (see Non-Patent Literature 1). In addition, for the purpose of further high capacity, advancement and the like of the LTE (Third Generation Partnership Project (3GPP (registered trademark)) Release (Rel.) 8 and Rel. 9), the specifications of LTE-Advanced (3GPP Rel. 10 to Rel. 14) have been drafted.

Successor systems of LTE (for example, also referred to as “5th generation mobile communication system (5G),” “5G+ (plus),” “6th generation mobile communication system (6G),” “New Radio (NR),” “3GPP Rel. 15 (or later versions),” and so on) are also under study.

### CITATION LIST

### Non-Patent Literature

Non-Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8),” April, 2010

### SUMMARY OF INVENTION

### Technical Problem

In future radio communication systems, a UE can use one of multi-panel (or multi-beam) for uplink (UL) transmission. It is studied that for improvement of UL throughput/reliability, simultaneous UL transmission (for example, simultaneous multi-panel UL transmission (SiMPUL/STxMP)) using a plurality of panels is supported for one or more transmission/reception points (TRPs).

In a case where the simultaneous multi-panel UL transmission is supported, the UE transmits ULs simultaneously from two panels, but reporting/calculation of PHR in this case remains unclear. For example, an event/condition for triggering the PHR remains unclear. This may prevent transmission control from being appropriately performed, which may reduce communication throughput.

In view of this, an object of the present disclosure is to provide a terminal, a radio communication method, and a base station that can appropriately perform transmission power control.

### Solution to Problem

A terminal according to one aspect of the present disclosure includes a transmitting section that transmits a physical uplink shared channel (PUSCH) by using simultaneous uplink (UL) transmission from multi-panel, and a control section that controls triggering of a power headroom (PHR) based on the PUSCH transmission, based on a specific condition.

### Advantageous Effects of Invention

One aspect of the present disclosure allows transmission power control to be appropriately performed.

### BRIEF DESCRIPTION OF DRAWINGS

FIGS. 1A to 1C are diagrams to show examples of PUSCH transmission using a plurality of panels.

FIGS. 2A and 2B are diagrams to show examples of PUCCH transmission using a plurality of panels.

FIG. 3 is a diagram to show an example of a single entry PHR MAC CE in Rel-16 NR.

FIG. 4 is a diagram to show an example of a multiple entry PHR MAC CE in Rel-16 NR.

FIG. 5 is a diagram to show an outline of PHR transmission.

FIGS. 6A to 6D are examples to show a MAC CE for PHR according to a second embodiment.

FIG. 7 is a diagram to show an example of a schematic structure of a radio communication system according to one embodiment.

FIG. 8 is a diagram to show an example of a structure of a base station according to one embodiment.

FIG. 9 is a diagram to show an example of a structure of a user terminal according to one embodiment.

FIG. 10 is a diagram to show an example of a hardware structure of the base station and the user terminal according to one embodiment.

FIG. 11 is a diagram to show an example of a vehicle according to one embodiment.

### DESCRIPTION OF EMBODIMENTS

### (Multi-Panel Transmission)

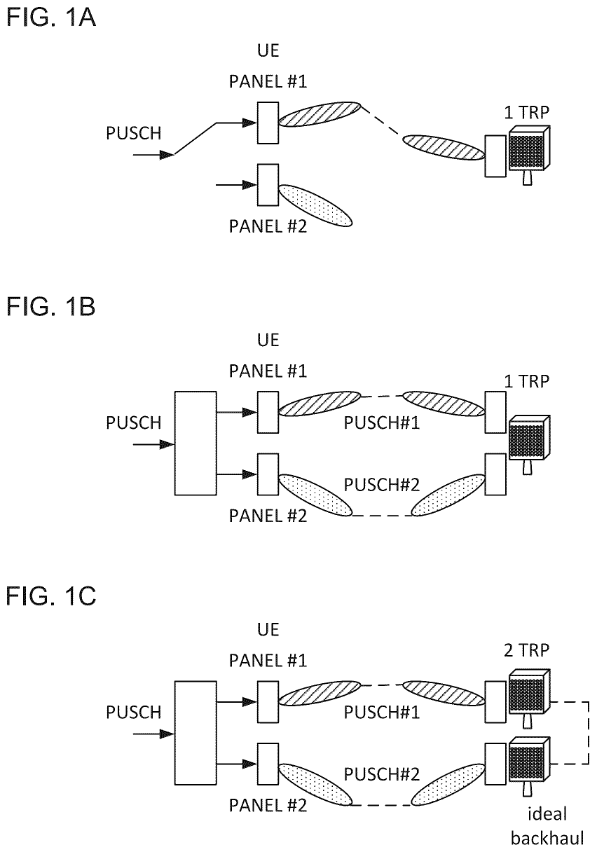

In a UE of each of Rel. 15 and Rel. 16, only one beam and panel are used for UL transmission at one timing (FIG. 1A). For Rel. 17, it is studied that simultaneous UL transmission with multi-beam (plurality of beams) and multi-panel (plurality of panels) is performed for one or more transmission/reception points (TRPs) to improve UL throughput and reliability.

For simultaneous UL transmission using multi-beam and multi-panel, reception by one TRP including multi-panel (FIG. 1B) or reception by two TRPs including an ideal backhaul (FIG. 1C) is under study. A single PDCCH for scheduling of a plurality of PUSCHs (for example, simultaneous transmission of PUSCH #1 and PUSCH #2) is under study. Support of panel-specific transmission and introduction of a panel ID are under study.

A base station may configure or indicate panel-specific transmission for UL transmission by using UL transmission configuration indication (TCI) or a panel ID. The UL TCI (UL TCI state) may be based on signaling similar to DL beam indication supported in Rel. 15. The panel ID may be implicitly or explicitly applied to transmission of at least/a target RS resource or target RS resource set, a PUCCH, an SRS, and a PRACH. When the panel ID is explicitly notified, the panel ID may be configured in at least one of a target RS, a target channel, and a reference RS (for example, DL RS resource configuration or spatial relationship information).

In simultaneous UL transmission using multi-panel, a UE may perform transmission of a plurality of physical uplink control channels (PUCCHs). As transmission schemes for simultaneous UL transmission using multi-panel for PUCCHs, Schemes 1 and 2 below are under study.

### {Scheme 1}

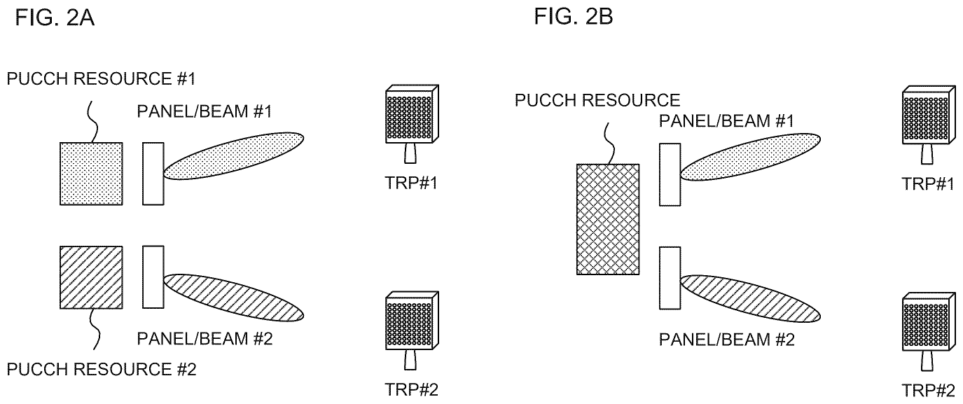

Two PUCCH resources overlap each other in a time domain, and are simultaneously transmitted. Each of the two PUCCH resources is associated with one different panel/beam (see FIG. 2A). Each of the two beams is transmitted to each TRP.

### {Scheme 2}

One PUCCH resource is simultaneously transmitted by using two panels/spatial relations. The one PUCCH resource is associated with two panels/beams (see FIG. 2B). Each of the two beams is transmitted to each TRP.

Note that the case where the number of multi-panel is two has been described as an example, but in the present disclosure, the number of panels may be 3 or greater. In other words, the number “2” of panels may be interpreted as a number greater than or equal to 3.

Note that Scheme 2 may be applied to repetition transmission (repetition) of an SEN (single frequency network) PUCCH.

In simultaneous UL transmission using multi-panel, the UE may perform transmission of a plurality of physical uplink shared channels (PUSCHs). As transmission schemes for simultaneous UL transmission using multi-panel for PUSCHs, Schemes 3 to 5 below are under study.

### {Scheme 3}

### Single-DCI (S-DCI) Based Space Division Multiplexing (SDM) Scheme:

in this scheme, different layers/DMRS ports for one PUSCH are separately precoded and simultaneously transmitted from different UE beams/panels. Note that, in the scheme, whether to support two CWs (codewords) and whether to perform simultaneous transmission from two different UE beams/panels are conceivable as problems to be studied.

### {Scheme 4}

### S-DCI Based SFN Scheme:

in this scheme, the same layers/DMRS ports for one PUSCH are all simultaneously transmitted from two different UE beams/panels.

### {Scheme 5}

### M-DCI Simultaneous PUSCH Transmission Scheme:

in this scheme, two independent PUSCHs associated with different TRPs are simultaneously transmitted in the same active BWP. For example, a total number of layers for the two PUSCHs may be up to four layers. Note that the number of layers for each of these two PUSCHs may be defined by a specification, and may be, for example, 1 to 3 layers or up to 2 layers.

### (UL TCI State)

For Rel-16 NR, it is studied that a UL TCI state is used as a UL beam indication method. Notification of the UL TCI state is similar to notification of a UE DL beam (DL TCI state). Note that the DL TCI state may be interpreted as a TCI state for a PDCCH/PDSCH, and vice versa.

A channel/signal for which the UL TCI state is configured (indicated) (which may be referred to as a target channel/RS) may be, for example, at least one of a PUSCH (PUSCH DMRS), a PUCCH (PUCCH DMRS), a random access channel (Physical Random Access Channel (PRACH)), an SRS, and the like.

An RS (source RS) being in a QCL relationship with the channel/signal may be, for example, a DL RS (for example, an SSB, a CSI-RS, a TRS, or the like) or a UL RS (for example, an SRS, an SRS for beam management, or the like).

In the UL TCI state, the RS being in a QCL relationship with the channel/signal may be associated with a panel ID for reception or transmission of the RS. The association may be explicitly configured (or indicated) by higher layer signaling (for example, RRC signaling, a MAC CE, or the like), or may be implicitly judged.

The correspondence between the RS and the panel ID may be configured to be included in UL TCI state information, or may be configured to be included in at least one of resource configuration information, spatial relation information, and the like for the RS.

A QCL type indicated by the UL TCI state may be existing QCL types A to D, may be another QCL type, or may include a certain spatial relation, a relevant antenna port (port index), and the like.

The UE may, when being indicated with a relevant panel ID (for example, being indicated by DCI) for UL transmission, perform the UL transmission by using a panel corresponding to the panel ID. The panel ID may be associated with a UL TCI state. The UE may, when being indicated (or activated) with a UL TCI state for a certain UL channel/signal, identify a panel to be used for transmission of the UL channel/signal, in accordance with a panel ID associated with the UL TCI state.

### (Transmission Power Control)

### <PUSCH Transmission Power Control>

In NR (for example, Rel. 16), transmission power for a PUSCH is controlled based on a TPC command (also referred to as a value, an increasing/decreasing value, a correction value, or the like) indicated by a value of a certain field (also referred to as a TPC command field or the like) in DCI.

For example, when the UE transmits the PUSCH on active UL BWP b on carrier f of serving cell c by using a parameter set with index j (open-loop parameter set), and index l of a power control adjustment state, transmission power for the PUSCH (P_{PUSCH,b,f,c} (i, j, q_{d}, l)) in PUSCH transmission occasion i (also referred to as a transmission period or the like) may be expressed by Equation (1) below.

$$\text{?} ( i , j , {q}_{d} , l ) \text{?} = min \{ \begin{matrix}\text{?} ( i ) , \\ \text{?} ( j ) + 10 {log}_{10} ( {2}^{μ} \cdot \text{?} ( i ) ) + \text{?} ( j ) \cdot P \text{?} + \text{?} ( i ) + \text{?} ( i , l ) ⌋\end{matrix} \} [ dBm ] \qquad ( 1 )$$

$$\text{?} \text{indicates text missing or illegible when filed}$$

Here, for the power control adjustment state, whether the power control adjustment state has a plurality of states (for example, 2 states) or a single state may be configured by a higher layer parameter. When a plurality of power control adjustment states are configured, one of the plurality of power control adjustment states may be identified by index l (for example, 1 €{0, 1}). The power control adjustment state may be referred to as a PUSCH power control adjustment state, a first or second state, or the like.

PUSCH transmission occasion i is a certain period in which the PUSCH is transmitted, and may be constituted, for example, by one or more symbols, one or more slots, or the like.

In Equation (1), P_{CMAX,f,c}(i) is, for example, transmission power (also referred to as maximum transmission power, UE maximum output power, or the like) of a user terminal configured for carrier f of serving cell c in transmission occasion i. P_{O_PUSCH,b,f,c}(j) is, for example, a parameter related to target received power configured for active UL BWP b on carrier f of serving cell c in parameter set configuration j (also referred to as, for example, a parameter related to transmission power offset, transmission power offset P0, a target received power parameter, or the like).

M^{PUSCH}_{RB,b,f,c}(i) is, for example, the number of resource blocks (bandwidths) allocated to the PUSCH for transmission occasion i in active UL BWP b on carrier f in serving cell c and with subcarrier spacing μ. α_{b,f,c}(j) is a value provided by a higher layer parameter (also referred to as, for example, msg3-Alpha, p0-PUSCH-Alpha, a fractional factor, or the like).

PL_{b,f,c}(q_{d}) is, for example, a pathloss (pathloss compensation) calculated in the user terminal by using index q_{d} of a reference signal (pathloss reference RS, pathloss measurement DL RS, PUSCH-PathlossReferenceRS) for a downlink BWP associated with active UL BWP b on carrier f of serving cell c.

Δ_{TF,b,f,c}(i) is a transmission power adjustment component (offset, transmission format compensation) for UL BWP b on carrier f of serving cell c.

f_{b,f,c}(i, l) is a value based on a TPC command with power control adjustment state index l described above for the active UL BWP on carrier f in serving cell c and transmission occasion i (for example, a power control adjustment state, an accumulated value of the TPC command, or a closed-loop value). l may be referred to as a closed-loop index.

When the UE is not provided with the pathloss reference RS (for example, PUSCH-PathlossReferenceRS) or when the UE is not provided with a dedicated higher layer parameter, the UE may calculate PL_{b,f,c}(q_{d}) by using an RS resource from an SSB used to obtain a Master Information Block (MIB).

When the UE is configured with RS resource indices up to a value of a maximum number of pathloss reference RSs (for example, maxNrofPUSCH-PathlossReferenceRS), and is configured with a set of respective RS configurations for the RS resource indices, by the pathloss reference RS, the set of RS resource indices may include one or both of a set of SS/PBCH block indices and a set of CSI-RS resource indices. The UE may identify RS resource index q_{d} in the set of RS resource indices.

When PUSCH transmission is scheduled by a Random Access Response (RAR) UL grant, the UE may use same RS resource index qa as that for corresponding PRACH transmission.

When the UE is provided with a PUSCH power control configuration based on a sounding reference signal (SRS) resource indicator (SRI) (for example, SRI-PUSCH-PowerControl), and is provided with one or more values of an ID of the pathloss reference RS, mapping between a set of values for an SRI field in DCI format 0_1 and a set of ID values for the pathloss reference RS may be obtained from higher layer signaling (for example, sri-PUSCH-PowerControl-Id in SRI-PUSCH-PowerControl). The UE may determine RS resource index q_{d}, based on an ID of the pathloss reference RS mapped to an SRI field value in DCI format 0_1 for scheduling a PUSCH.

When PUSCH transmission is scheduled by DCI format 0_0, and the UE is not provided with PUCCH spatial relation information for a PUCCH resource having the lowest index for active UL BWP b on each carrier f and in serving cell c, the UE may use same RS resource index q_{d} as that for PUCCH transmission in the PUCCH resource.

When PUSCH transmission is scheduled by DCI format 0_0, and the UE is not provided with a spatial setting for PUCCH transmission, when PUSCH transmission is scheduled by DCI format 0_1 not including an SRI field, or when an SRI-based PUSCH power control configuration is not provided for the UE, the UE may use RS resource index q_{d} having a pathloss reference RS ID of zero.

When, for PUSCH transmission configured by a configured grant configuration (for example, ConfiguredGrantConfig), the configured grant configuration includes a certain parameter (for example, rrc-ConfiguredUplinkGrant), RS resource index q_{d} may be provided for the UE by a pathloss reference index (for example, pathlossReferenceIndex) in the certain parameter.

When, for the PUSCH transmission configured by the configured grant configuration, the configured grant configuration does not include the certain parameter, the UE may determine RS resource index q_{d}, based on a pathloss reference RS ID value mapped to an SRI field in a DCI format for activating PUSCH transmission. When the DCI format does not include an SRI field, the UE may determine RS resource index q_{d} having a pathloss reference RS ID of zero.

### <PUCCH Transmission Power Control>

In NR, transmission power for a PUCCH is controlled based on a TPC command (also referred to as a value, an increasing/decreasing value, a correction value, an indicated value, or the like) indicated by a value of a certain field (also referred to as a TPC command field, a first field, or the like) in DCI.

For example, by using index l of a power control adjustment state, transmission power for the PUCCH (P_{PUCCH,b,f,c}(i, qᵤ, q_{d}, l)) in PUCCH transmission occasion i (also referred to as a transmission period or the like) for active UL BWP b on carrier f of serving cell c may be expressed by Equation (2) below.

$$\text{?} ( i , \text{?} ) \text{?} = min \{ \begin{matrix}\text{?} ( i ) , \\ \text{?} 10 {log}_{10} ( {2}^{μ} \text{?} ( i ) ) + P \text{?} ( {q}_{d} ) + \text{?} ( F ) + \text{?} ( i ) + \text{?}\end{matrix} \} [ dBm ] \qquad ( 2 )$$

$$\text{?} \text{indicates text missing or illegible when filed}$$

The power control adjustment state may be referred to as a PUCCH power control adjustment state, a first or second state, or the like.

PUCCH transmission occasion i is a certain period in which the PUCCH is transmitted, and may be constituted, for example, by one or more symbols, one or more slots, or the like.

In Equation (2), P_{CMAX,f,c}(i) is, for example, transmission power (also referred to as maximum transmission power, UE maximum output power, or the like) of a user terminal configured for carrier f of serving cell c in transmission occasion i. P_{O_PUCCH,b,f,c}(qᵤ) is, for example, a parameter related to target received power configured for active UL BWP b on carrier f of serving cell c in transmission occasion i (also referred to as, for example, a parameter related to transmission power offset, transmission power offset P0, a target received power parameter, or the like).

M^{PUCCH}_{RB,b,f,c}(i) is, for example, the number of resource blocks (bandwidths) allocated to the PUCCH for transmission occasion i in active UL BWP b on carrier f in serving cell c and with subcarrier spacing μ. PL_{b,f,c}(q_{d}) is, for example, a pathloss calculated in the user terminal by using index q_{d} of a reference signal (pathloss reference RS, pathloss measurement DL RS, PUCCH-PathlossReferenceRS) for a downlink BWP associated with active UL BWP b on carrier f of serving cell c.

Δ_{F_PUCCH}(F) is a higher layer parameter given for each PUCCH format. Δ_{TF,b,f,c}(i) is a transmission power adjustment component (offset) for UL BWP b on carrier f of serving cell c.

g_{b,f,c}(i, l) is a value based on a TPC command with power control adjustment state index l described above for the active UL BWP on carrier f in serving cell c and transmission occasion i (for example, a power control adjustment state, an accumulated value of the TPC command, a closed-loop value, or a PUCCH power adjustment state).

If the UE is provided with information (twoPUCCH-PC-AdjustmentStates) indicating use of two PUCCH power control adjustment states, and PUCCH spatial relation information (PUCCH-SpatialRelationInfo), l may equal {0, 1}. If the UE is not provided with the information indicating use of two PUCCH power control adjustment states or the PUCCH spatial relation information, l may equal 0.

If the UE obtains a TPC command value from DCI format 1_0 or DCI format 1_1, and the UE is provided with the PUCCH spatial relation information, the UE may obtain mapping between a PUCCH spatial relation information ID (pucch-SpatialRelationInfoId) value and a closed-loop index (closedLoopIndex, power adjustment state index l) by using an index provided by a PUCCH P0 ID (p0-PUCCH-Id in p0-Set in PUCCH-PowerControl in PUCCH-Config). When the UE receives an activation command including a value of the PUCCH spatial relation information ID, the UE may determine, via a link to a corresponding PUCCH P0 ID, a value of the closed-loop index for providing an 1 value.

If the UE is provided with a configuration of a P_{O_PUCH,b,f,c}(qᵤ) value for corresponding PUCCH power adjustment state l, by a higher layer, for active UL BWP b on carrier f of serving cell c, g_{b,f,c}(i, l)=0, and k=0, 1, . . . , i. If the UE is provided with the PUCCH spatial relation information, the UE may determine, based on the PUCCH spatial relation information associated with a PUCCH P0 ID corresponding to qᵤ and a closed-loop index value corresponding to l, an l value based on the qᵤ value.
qᵤ may be a PUCCH P0 ID (p0-PUCCH-Id) indicating PUCCH P0 (P0-PUCCH) in a PUCCH P0 set (p0-Set).

### <SRS Transmission Power Control>

For example, by using index l of a power control adjustment state, transmission power for an SRS (P_{SRS,b,f,c}(i, qₛ, l)) in sounding reference signal (SRS) transmission occasion i (also referred to as a transmission period or the like) for active UL BWP b on carrier f of serving cell c may be expressed by Equation (3) below.

The power control adjustment state may be referred to as an SRS power control adjustment state, a value based on a TPC command, an accumulated value of a TPC command, a closed-loop value, a first or second state, or the like. I may be referred to as a closed-loop index.

SRS transmission occasion i is a certain period in which the SRS is transmitted, and may be constituted, for example, by one or more symbols, one or more slots, or the like.

$$\text{?} = min \{ \begin{matrix}\text{?} ( i ) , \\ \text{?} + 10 {log}_{10} ( {2}^{μ} \text{?} ( i ) ) + \text{?} \cdot P \text{?} ( {q}_{d} ) + \text{?} ( i , l )\end{matrix} \} [ dBm ] \qquad ( 3 )$$

$$\text{?} \text{indicates text missing or illegible when filed}$$

In Equation (3), P_{CMAX,f,c}(i) is, for example, UE maximum output power for carrier f of serving cell c in SRS transmission occasion i. P_{O_SRS,b,f,c}(qₛ) is a parameter related to target received power (also referred to as, for example, a parameter related to transmission power offset, transmission power offset P0, a target received power parameter, or the like) provided by p0 for active UL BWP b on carrier f of serving cell c and for SRS resource set qₛ (provided by SRS-ResourceSet and SRS-ResourceSetId).

M_{SRS,b,f,c}(i) is an SRS bandwidth represented by the number of resource blocks for SRS transmission occasion i on active UL BWP b on carrier f in serving cell c and with subcarrier spacing μ.

α_{SRS,b,f,c}(qₛ) is provided by α (for example, alpha) for active UL BWP b on carrier f in serving cell c and with subcarrier spacing μ, and for SRS resource set qₛ.

PL_{b,f,c}(q_{d}) is a DL path loss estimated value [dB] calculated by the UE using RS resource index q_{d}, for an active DL BWP in serving cell c and SRS resource set qₛ. RS resource index q_{d} is a path loss reference RS (path loss measurement DL RS, provided, for example, by pathlossReferenceRS) associated with SRS resource set qₛ, and is an SS/PBCH block index (for example, ssb-Index) or a CSI-RS resource index (for example, csi-RS-Index).

h_{b,f,c}(i, l) is an SRS power control adjustment state for the active UL BWP on carrier f of serving cell c and for SRS transmission occasion i. When a configuration of the SRS power control adjustment state (for example, srs-PowerControlAdjustmentStates) indicates the same power control adjustment state for SRS transmission and PUSCH transmission, h_{b,f,c}(i, l) is the same as current PUSCH power control adjustment state f_{b,f,c}(i, l).

Transmission occasions i for the PUSCH, the PUCCH, and the SRS may each be defined by slot index n_{s,f}_{^{μ}} in a frame with a system frame number SFN, first symbol S in a slot, and number L of consecutive symbols. In PUSCH transmission of repetition type B, a PUSCH transmission occasion may be nominal repetition.

### (Power Requirement)

For NR, studies have been carried out on responses to an issue of Maximum Permitted Exposure (MPE) (or electromagnetic power density exposure). The UE is required to satisfy, for health and safety, Federal Communication Commission (FCC) regulations related to maximum radiation into the human body.

For example, for Rel-15 NR, limitation using power-management maximum power reduction (P-MPR/PMPR, maximum permitted UE output power reduction) is defined to limit exposure. For example, in a case of non-carrier aggregation (CA), UE maximum output power P_{CMAX,f,c} is configured such that corresponding P_{UMAX,f,c} (maximum output power to be measured, configured maximum UE output power to be measured) satisfies Equation (4) below.

$$\text{?} + \text{?} - MAX ( MAX ( \text{?} ) + \text{?} ) - MAX \text{?} MAX \text{?} \leq \text{?} \leq \text{?} \qquad ( 4 )$$

$$\text{?} \text{indicates text missing or illegible when filed}$$

EIRPₘₐₓ is assumed to be a maximum value of corresponding measurement peak effective isotropic radiated power (EIRP). P-MPR_{f,c} is assumed to be a value indicating reduction of maximum output power permitted for carrier f of serving cell c. P-MPR_{f,c} is introduced to an equation of UE maximum output power P_{CMAX,f,c} configured for carrier f of serving cell c. Corresponding total radiated power P_{TMAX,f,c} satisfies P_{TMAX,f,c}≥TRPₘₐₓ.

In a case of carrier aggregation (CA), UE maximum output power P_{CMAX,f,c} is configured such that corresponding P_{UMAX,f,c} satisfies Equation (5) below.

$$\text{?} - MAX ( MAX \text{?} - MAX ( \text{?} ( MAX \text{?} \leq \text{?} \leq \text{?} \qquad ( 5 )$$

$$\text{?} \text{indicates text missing or illegible when filed}$$

P_{UMAX} measured for the carrier aggregation is defined as P_{UMAX}=Σ_{c,f(c)}P_{UMAX,f,c}. Here, P_{UMAX,f,c} is a linear value of measured power P_{UMAX,f,c} for carrier f=f(c) of serving cell c. Measured total radiated power P_{TMAX} for the carrier aggregation is defined as P_{TMAX}=10 log₁₀Σ_{c,f(c)}P_{TMAX,f,c}. Here, P_{TMAX} is a linear value of a measured value of total radiated power P_{TMAX,f,c} for carrier f=f(c) of serving cell c. A boundary is defined such that total radiated power P_{TMAX} satisfies P_{TMAX}≤TRPₘₐₓ.

In other words, the UE can configure the maximum output power as P_{CMAX} such that measured peak EIRP (P_{UMAX}) is within a range from a lower limit to an upper limit and measured total radiated power P_{TMAX} satisfies P_{TMAX}≤TRPₘₐₓ.

### (Multi-TRP)

For NR, it is studied that one or a plurality of transmission/reception points (TRPs) (multi-TRP (M-TRP)) perform DL transmission to a UE by using one or a plurality of panels (multi-panel). It is also studied that the UE performs UL transmission to the one or plurality of TRPs.

Incidentally, for future radio systems (for example, Rel-17 (or later versions) NR), it is studied that a plurality of (for example, two) SRS resource indicators (SRIs)/transmitted precoding matrix indicators (TPMIs) are indicated by using single piece of DCI (single DCI, S-DCI) for PUSCH repetition transmission with a plurality of TRPs (MTRP PUSCH repetition).

For example, in a case of codebook based transmission, the UE may determine a precoder for PUSCH transmission, based on an SRI, a transmitted rank indicator (TRI), and a TPMI. In a case of non-codebook based transmission, the UE may determine a precoder for PUSCH transmission, based on an SRI. Note that the SRI may be indicated for the UE by DCI, or may be given by a higher layer parameter.

When the single piece of DCI indicates a plurality of SRIs/TPMIs, Option 1 or Option 2 below is conceivable;
Option 1: an SRI/TPMI (value) for a plurality of (for example, two) TRPs is indicated by using a field for indicating a plurality of (for example, two) SRIs/TPMIs; and
Option 2: a field for indicating one SRI/TPMI is indicated, and the field for indicating the SRI/TPMI is configured with a codepoint corresponding to values of a plurality of (for example, two) SRIs/TPMIS.

In Option 1, a codepoint of each of a plurality of SRI/TPMI fields may correspond to one TPMI value. Correspondence (association) between SRI/TPMI fields and SRI/TPMI values may be predefined by a specification. The correspondence (association) between SRI/TPMI fields and SRI/TPMI values may use correspondence defined in Rel. 16 (or earlier versions), or may be correspondence defined in Rel. 17 (or later versions). The correspondence between SRI/TPMI fields and SRI/TPMI values may differ for each plurality of SRI/TPMI fields.

In Option 2, a codepoint indicated with one SRI/TPMI field may correspond to a plurality of (for example, two) SRI/TPMI values. Correspondence (association) between SRI/TPMI fields and SRI/TPMI values may be predefined by a specification, or may be notified/configured/activated by RRC signaling/MAC CE.

Note that it is studied that dynamic indication of/switching between single PUSCH transmission/PUSCH repetition transmission using a single TRP (STRP) and PUSCH repetition transmission using a plurality of TRPs (Multi TRP (MTRP)) is performed by DCI. For the dynamic switch, a specific field defined in Rel. 16 (or earlier versions) and included in DCI may be used, or a specific field defined in Rel. 17 (or later versions) (for example, a field for indicating STRP or MTRP operation) may be used.

“Dynamic switch” in the present disclosure may mean “switch using at least one of higher layer signaling and physical layer signaling.” “Switch” in the present disclosure may be interpreted as switching, change, changing, application, indication, configuration, and the like, and vice versa.

### (PHR)

In future radio communication systems (for example, NR), a UE transmits, to a network, a PH report (Power Headroom Report (PHR)) including information on power headroom (PH) per serving cell. The network can use the PHR for uplink transmission power control by the UE.

It is studied that, in a case where an M-TRP PUSCH is supported/configured/enabled and where reporting of two PHRs for two TRPs is configured/enabled, a PHR MAC CE includes two PHRs (first PHR and second PHR). The reporting of two PHRs for two TRPs may be configured for the UE by a higher layer parameter (RRC parameter).

Here, the first PHR may be reported in a manner similar to that of Rel. 15/16. The second PHR may be a PHR for a TRP different from that of the first PHR. The second PHR may be reported as an actual PHR or a virtual PHR.

The actual PHR is a PHR based on actual PUSCH transmission, and may be referred to as a real PHR. The actual PHR may be computed based on a power control parameter for actual PUSCH transmission.

The virtual PHR is a PHR (based on reference PUSCH transmission) independent of actual PUSCH transmission, and may be referred to as a reference PHR, a PHR following a reference format, or the like. The virtual PHR may be computed based on a default power control parameter already defined in Rel-15/16 NR, or may be computed based on a new default power control parameter.

When the UE judges that a type 1 power headroom report for an active serving cell is based on actual PUSCH transmission, for PUSCH transmission occasion i on active UL BWP b on carrier f of serving cell c, the UE calculates the type 1 power headroom report in accordance with Equation (6) below. The PHR of Equation (6) may be referred to as an actual PHR.

$$P \text{?} ( i , j , \text{?} ) = \text{?} ( i ) - \{ \text{?} 10 {log}_{10} ( \text{?} ( i ) ) + \text{?} P \text{?} + \text{?} ( i ) + \text{?} [ dB ] \qquad ( 6 )$$

$$\text{?} \text{indicates text missing or illegible when filed}$$

When the UE judges that a type 1 power headroom report for an active serving cell is based on reference PUSCH transmission, for PUSCH transmission occasion i on active UL BWP b on carrier f of serving cell c, the UE calculates the type 1 power headroom report in accordance with Equation (7) below. The PHR of Equation (7) may be referred to as a virtual PHR.

$$P \text{?} ( i , j \text{?} ) = \text{?} ( i ) - \{ \text{?} ( j ) + 10 {log}_{10} ( \text{?} ( i ) ) + \text{?} P \text{?} ( {q}_{d} ) + \text{?} + \text{?} [ dB ] \qquad ( 7 )$$

$$\text{?} \text{indicates text missing or illegible when filed}$$

Here, P_{CMAX,f,c}(i) bar (which is obtained by adding ~ to the top of P of P_{CMAX,f,c} (i)) is calculated based on the assumption that MPR=0 dB, A-MPR=0 dB, P-MPR=0 dB, and ΔT_{C}=0 dB. The A-MPR means Additional MPR. Regarding the remaining parameters, for P_{O_PUSCH,b,f,c}(j) and α_{b,f,c}(j), and PL_{b,f,c}(q_{d}), P_{O_NOMINAL_PUSCH,f,c}(0), p0-PUSCH-AlphaSetId=0 and pusch-PathlossReferenceRS-Id=0, l=0 are used, respectively.

### (PHR MAC CE)

A PHR may be transmitted by MAC (Medium Access Control) signaling using a PUSCH (Physical Uplink Shared Channel). For example, the PHR is notified by using a PHR MAC CE (Control Element) included in a MAC PDU (Protocol Data Unit).

NR supports a single entry PHR MAC CE related to a primary cell (PCell).

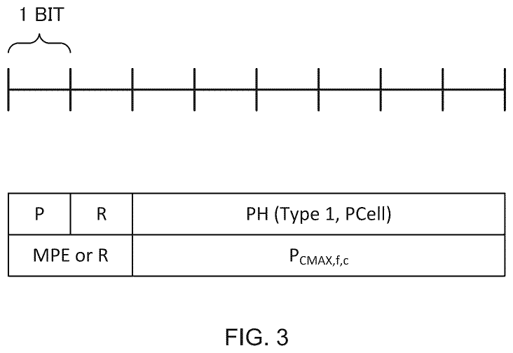

FIG. 3 is a diagram to show an example of the single entry PHR MAC CE in Rel-16 NR. The MAC CE is constituted by two octets (=16 bits). ‘R’s of FIG. 3 indicate respective 1-bit reserved fields, and are set to ‘0’ values, for example.

‘PH (Type 1, PCell)’ of FIG. 3 indicates a 6-bit field, and indicates an index related to type 1 PH for a primary cell (PCell). The index related to the PH is associated with a specific PH value (decibel (dB) unit) (or level).

Note that, for example, type 1 PH may be PH with consideration of a PUSCH (for example, consideration of only power for a PUSCH), type 2 PH may be PH with consideration of a PUCCH (for example, consideration of power for both a PUSCH and a PUCCH), and type 3 PH may be PH with consideration of a sounding reference signal (SRS) (for example, consideration of power for a PUSCH and an SRS).

‘P_{CMAX,f,c}’ of FIG. 3 indicates a 6-bit field, and indicates an index related to P_{CMAX,f,c} used for calculation of the above-described PH field. The index related to P_{CMAX,f,c} is associated with a specific UE transmission power level (dB). Note that P_{CMAX,f,c} may be referred to as configured UE maximum transmission power (maximum permitted transmission power) for serving cell c of carrier f. P_{CMAX,f,c} may be simply expressed hereinafter as P_{CMAX}, P_{CMAX}, or the like.

‘P’ of FIG. 3 may be a field related to power management maximum power reduction (P-MPR or maximum permitted UE output power reduction) for serving cell c, or may be a field associated with maximum permitted exposure (MPE). ‘MPE’ of FIG. 3 may be a field associated with MPE. Such a field as ‘P,’ ‘MPE,’ or the like may be interpreted as an ‘R’ field, depending on configuration using higher layer signaling for the UE.

When MPE reporting for FR2 (higher layer parameter “mpe-Reporting-FR2”) is configured, and the serving cell operates at FR2, the ‘P’ field is set to 0 if a P-MPR value applied for satisfying an MPE request is less than a specific P-MPR value (for example, P-MPR_00), otherwise the ‘P’ field is set to 1.

When MPE reporting for FR2 is not configured, or the serving cell operates at FR1, the ‘P’ field may indicate whether power backoff is applied for power management. Note that, if the power backoff is not applied for the power management, the ‘P’ field is set to 1 when a corresponding P_{CMAX} field is configured to have a different value.

When MPE reporting for FR2 (higher layer parameter “mpe-Reporting-FR2”) is configured, the serving cell operates at FR2, and the ‘P’ field is set to 1, the ‘MPE’ field may indicate power backoff applied for satisfying an MPE request. This field may indicate an index corresponding to a measured P-MPR value (for example, dB unit).

When the MPE reporting for FR2 is not configured, the serving cell operates at FR1, or the ‘P’ field is set to 0, an R field (R bit) may be present in place of the ‘MPE’ field.

NR also supports a multiple entry PHR MAC CE including a plurality of data similar to the above-described single entry (2 octets). The multiple entry PHR MAC CE may include PH fields for a primary secondary cell (PSCell) and a secondary cell (SCell), and the like. Note that the PCell and the PSCell may be referred to as special cells (SpCells).

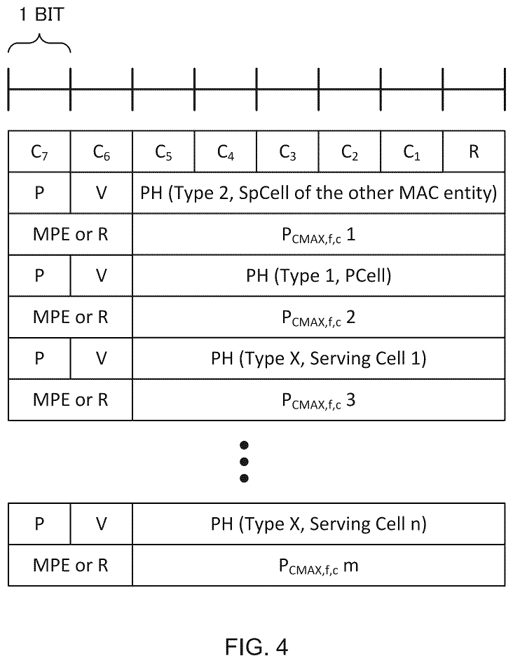

FIG. 4 is a diagram to show an example of the multiple entry PHR MAC CE in Rel-16 NR. Description of fields similar to those of FIG. 3 will not be repeated. 6-bit fields including the words ‘PH’ in FIG. 4 indicate PH fields for respective corresponding types (for example, types 1 to 3 described above) and cells.

Note that the presence of a type 2 PH field for an SpCell of another MAC entity may be configured by a higher layer parameter “phr-Type2OtherCell” being true.

A 6-bit field including the word ‘P_{CMAX,f,c}’ in FIG. 4 is a P_{CMAX,f,c} field indicating P_{CMAX,f,c} used for calculation of an immediately preceding PH field. ‘Cᵢ’ of FIG. 4 is a field indicating whether the PHR includes a PH field of a serving cell corresponding to serving cell index i. Note that FIG. 4 shows a case where a maximum serving cell index is less than 8, and when the index is 8 or more, the MAC CE may include a ‘Cᵢ’ field capable of indicating a serving cell with i=31 or below, for example.

Note that the number added to “serving cell” in the PH field and the number added to the P_{CMAX,f,c} field may not indicate serving cell indices, and may simply indicate which values included in the MAC CE these fields correspond to.

‘V’ of FIG. 4 is a field indicating whether a value of PH corresponding to an immediately following PH field is based on actual transmission (real transmission) (V=0) or a reference format (V=1). The PH based on the reference format may be referred to as virtual PH. Note that, when V=1, corresponding ‘P_{CMAX,c}’ field, ‘MPE’ field, and the like may be omitted.

The network may transmit, to the UE, PHR configuration information related to a condition for triggering a PHR. Here, the PHR configuration information includes, for example, a prohibit timer, a periodic timer, a pathloss change threshold (phr-Tx-PowerFactorChange), and so on. For the notification, higher layer signaling may be used. The UE triggers the PHR when the PHR trigger condition is satisfied.

(Maximum Transmission power)

An example of configuration of maximum transmission power (maximum output power) P_{CMAXpanel,f,c,p} in panel p on carrier f of serving cell c will be described. P_{CMAXpanel,f,c,p} may be expressed as P_{CMAX,f,c,p}.

### <<Option 0>>

The UE may receive a configuration related to maximum transmission power per serving cell and per carrier (for example, the same configuration as that for Rel. 17), and may determine, based on the configuration, maximum transmission power per panel. For example, the UE may be configured with maximum transmission power for carrier f of serving cell c, as P_{CMAX,f,c}, and may determine maximum transmission power P_{CMAX,f,c,p} for each panel p, based on P_{CMAX,f,c} or a relationship between P_{CMAX,f,c} and P_{CMAX,f,c,p}. P_{CMAX,f,c} and the relationship may be configured for the UE by higher layer signaling/physical layer signaling. For the maximum transmission power per panel in this case, the following examples are conceivable.

### <<Option 0-1>>

The UE may determine maximum transmission power P_{CMAX,f,c,p} for panel p, based on Equation (8) below. N is the number of panels indicated with simultaneous transmission. In other words, maximum transmission power may be the same for each panel.

$${P}_{CMAX , f , c} = N \cdot {P}_{{CMAX}_{panel} , f , c , p} \qquad ( 8 )$$

For example, N may equal 2 when multi-panel simultaneous transmission is indicated. N may equal 1 when single-panel transmission is indicated. Alternatively, N may follow at least one of a value configured by a network (base station) using higher layer signaling/physical layer signaling, and a UE capability. A value that differs between the single-panel transmission and the multi-panel transmission may be applied to N. Alternatively, N may be a maximum number of panels supported by the UE in UL transmission (for example, N=2), and application of the single-panel transmission or the simultaneous multi-panel transmission may not be indicated by the network.

### <<Option 0-2>>

The UE may determine maximum transmission power P_{CMAX,f,c,p} for panel p, based on Equation (9) below. In other words, total maximum transmission power of maximum transmission power for respective panels p may be maximum transmission power of the UE. Np is a value for panel p, and may differ for each panel. In other words, maximum output power may differ for each panel.

$${P}_{CMAX , f , c} = {N}_{p} \cdot {P}_{{CMAX}_{panel , f , c , p}} \qquad ( 9 )$$

Np may follow at least one of a value configured by a network (base station) using higher layer signaling/physical layer signaling, and a UE capability. A value that differs between the single-panel transmission and the multi-panel transmission may be applied to Np.

### <<Option 0-3>>

The UE may determine maximum transmission power P_{CMAX,f,c,p} for panel p, based on Equation (10) below. In other words, total maximum transmission power of maximum transmission power for respective panels p may be maximum transmission power of the UE. In this case, the maximum transmission powers for the respective panels may be the same or different from each other, or maximum transmission powers for some of the panels may be the same.

$${P}_{CMAX , f , c} = {\sum }_{p} \cdot {P}_{{CMAX}_{panel , f , c , p}} \qquad ( 10 )$$

This clarifies maximum transmission power for panel p, maximum transmission power for all the panels, and a relationship between these transmission powers, thereby allowing a UE to control simultaneous multi-panel UL transmission by using appropriate transmission power.

### (Reporting of M-TRP PHR in Rel. 17)

In M-TRP PUSCH repetitions in Rel. 17, when a PHR MAC CE is reported in slot n, a first PHR for a first TRP is reported in a manner similar to that of Rel. 16. A second PHR for a second TRP may be defined as (1) to (3) below.
(1) When the first PHR is an actual PHR, and PUSCH repetitions associated with the second TRP are present in slot n, the second PHR is an actual PHR.
(2) When the first PHR is an actual PHR, and PUSCH repetitions associated with the second TRP are absent in slot n, the second PHR is a virtual PHR.
(3) When the first PHR is a virtual PHR, the second PHR is a virtual PHR.

The virtual PHR may be calculated by using a default power control parameter (p0, alpha (α), PL-RS, closedloopindex) per TRP.

In a case where the UE is provided with twoPHRMode in active UL BWP b on carrier f of serving cell c, and is provided with two SRS resource sets with usage set to “codebook” or “nonCodebook,” by srs-ResourceSetToAddModList or srs-ResourceSetToAddModListDCI-0-2, the UE provides first power headroom reports of two types, (1) and (2) below. (1) and (2) are based on the assumption that the UE provides a first type 1 PHR for actual PUSCH repetitions for the earliest PUSCH transmission in a slot associated with one SRS resource set.
(1) When the UE transmits, in slot n, PUSCH repetitions associated with another SRS resource set, the UE provides a second type 1 power headroom report for the first actual PUSCH repetition overlapping slot n and associated with another SRS resource set.
(2) Otherwise (when the condition of (1) is not satisfied), the UE provides a second type 1 power headroom report for reference PUSCH transmission associated with another SRS resource set.

### (UE Capability and so on)

In the present disclosure, a “panel” may indicate a value (value set) of a UE capability in a manner similar to that of Rel. 17. The “panel” may indicate a definition equivalent to another terminology, such as a “UE antenna group.”

A beam may indicate a spatial relation/TCI/spatial relation information (SRI). A TRP may refer to CORESETPool/SRS resource set.

In simultaneous multi-panel transmission (simultaneous multi-panel Tx (STxMP)), the following schemes may be applied.
Single-DCI (S-DCI) space division multiplexing (SDM) scheme: different layers/DMRS ports for one PUSCH are separately precoded and simultaneously transmitted from different UE beams/panels.
S-DCI frequency division multiplexing (FDM)-A scheme: different parts of a frequency domain resource for one PUSCH transmission occasion are transmitted from different UE beams/panels.
S-DCI FDM-B scheme: two PUSCH transmission occasions with same/different RVs of the same TB are transmitted from different UE beams/panels on non-overlapping frequency domain resources and the same time domain resource.
S-DCI SFN-based transmission scheme: the same PUSCHs/DMRSs are simultaneously transmitted from two different UE beams/panels.
S-DCI space domain repetition scheme: two PUSCH transmission occasions with different redundancy versions (RVs) of the same TB are transmitted from two different UE beams/panels on the same time and frequency resources.
M-DCI scheme: two PUSCHs overlapping each other (fully/partially overlapping each other in a time domain, fully/partially overlapping or non-overlapping each other in a frequency domain) are transmitted from two different UE beams/panels.

The simultaneous multi-panel transmission is based on the assumption of multi-TRP, and it is considered that one panel corresponds to one TRP. Accordingly, in the present disclosure, a PUSCH associated with a panel and a PHR/power for a panel may also be referred to as a PUSCH associated with a TRP and a PHR/power for a TRP, respectively.

In the present disclosure, it can be considered that the UE receives a PUSCH/SRS with one panel and receives a PUCCH/SRS in a time resource fully/partially overlapping PUSCH reception with another panel (performs simultaneous multi-panel reception).

“Single-panel transmission” in the present disclosure may be applied to only a case where PUSCH transmission with a single panel is present and where PUCCH/SRS transmission with another panel is absent on a time resource fully/partially overlapping the PUSCH transmission. Note that this case requires further studies of how to handle PHR reporting, such as a case that one type 1 PHR based on a PUSCH and one type 3 PHR based on an SRS are reported in a case of PUSCH+SRS.

Alternatively, “single-panel transmission” in the present disclosure may also be applied to a case where PUSCH transmission with a single panel is present and where PUCCH/SRS transmission with another panel on a time resource fully/partially overlapping the PUSCH transmission is present.

### (Assumption for Simultaneous Multi-Panel UL Transmission)

In a case of simultaneous multi-panel UL transmission, considering limitation on maximum UL transmission power, at least one of Assumptions 1-1 to 1-3 below is assumed.

### {Assumption 1-1}

Maximum UL transmission power per panel is considered. It is assumed that actual PUSCH/PUCCH/SRS transmission power for panel p in serving cell c is less than or equal to maximum UL transmission power for panel p in serving cell c. In other words, P_{panel_actual,c,p}≤P_{panel_max,c,p} is satisfied. The maximum UL transmission power for panel p in serving cell c may be calculated by any one of Equations (8) to (10) (maximum transmission power) described above. Note that the element of carrier f may be removed when a carrier is not specified.

P_{panel_actual,c,p} is actual transmission power for serving cell c and panel p, and P_{panel_max,c,p} is maximum UL transmission power for serving cell c and panel p.

### {Assumption 1-2}

Maximum UL transmission power per cell is considered. It is assumed that actual total PUSCH/PUCCH/SRS transmission power from a plurality of panels in serving cell c is less than or equal to maximum UL transmission power in serving cell c. In other words, ΣₚP_{panel_actual,c,p}≤P_{cell_max,c} is satisfied.

Note that the maximum UL transmission power in serving cell c may be a value determined in Rel. 17 (that is, P_{CMAX,f,c}).
P_{panel_actual,c,p} is actual transmission power for panel p in serving cell c, and P_{cell_max,c} is maximum UL transmission power in serving cell c.

### {Assumption 1-3}

Both of the maximum UL transmission power per panel and the maximum transmission power per cell may be considered. Transmission power may satisfy both of the conditions of Assumptions 1 and 2.

### (Assumption for Single-Panel UL Transmission)

In a case where dynamic switching between single-panel transmission and simultaneous multi-panel transmission is supported, considering limitation on maximum UL transmission power, at least one of Assumptions 2-1 and 2-2 below is assumed.

### {Assumption 2-1}

Maximum UL transmission power per panel is considered. It is assumed that actual PUSCH/PUCCH/SRS transmission power for single-panel transmission with panel p in serving cell c is less than or equal to maximum UL transmission power for panel p in serving cell c. In other words, P_{panel_actual,c,p}≤P_{panel_max,c,p} is satisfied.

P_{panel_actual,c,p} is actual transmission power for serving cell c and panel p, and P_{panel_max,c,p} is maximum UL transmission power for serving cell c and panel p.

### {Assumption 2-2}

Maximum UL transmission power per cell is considered. It is assumed that actual total PUSCH/PUCCH/SRS transmission power from a single panel in serving cell c is less than or equal to maximum UL transmission power in serving cell c. In other words, P_{panel_actual,c,p}≤P_{cell_max,c} is satisfied. Note that the maximum UL transmission power in serving cell c may be a value determined in Rel. 17 (that is, P_{CMAX,f,c}).

P_{panel_actual,c,p} is actual transmission power for panel p in serving cell c, and P_{cell_max,c} is maximum UL transmission power in serving cell c.

Note that, in a case of single-panel transmission, Assumption 2-1 and Assumption 2-2 are the same if P_{panel_max,c,p} and P_{cell_max,c} are the same.

### (Triggering of PHR)

In an existing specification (for example, Rel. 17), a PHR may be triggered based on at least one of the following events/conditions:
when a PHR prohibit timer (phr-ProhibitTimer) expires/when the timer has expired, a MAC entity includes a UL resource for new transmission, and after last PHR transmission in the MAC entity, a path loss has changed more than a certain threshold (phr-Tx-PowerFactorChange (dB)), for at least one reference signal used as a pass loss reference for one activated serving cell corresponding to any MAC entity with an active DL BWP not being a dormant BWP;
when a PHR periodic timer (phr-PeriodicTimer) expires;
when a PHR function is configured/reconfigured by higher layer signaling (note that the higher layer signaling may not be used to disable the PHR function);
when an SCell corresponding to a MAC entity configured with UL with firstActiveDownlinkBWP-Id not set for a dormant BWP is activated;
when an SCG is activated;
when a PSCell is added (that is, when a PSCell is newly added/changed), except for a case where an SCG is deactivated;
when a PHR prohibit timer (phr-ProhibitTimer) expires/when the timer has expired, a MAC entity includes a UL resource for new transmission, and for an activated serving cell corresponding to any MAC entity configured with UL, the following is satisfied:
a case where a UL resource allocated for transmission/PUCCH transmission is present in this cell (the activated serving cell) and where, after last PHR transmission, requested power backoff for power management for this cell has changed more than a certain threshold (phr-Tx-PowerFactorChange (dB));
when an activated dormant BWP of an SCell corresponding to any MAC entity configured with UL is switched to a non-dormant BWP;
a case where a higher layer parameter “mpe-Reporting-FR2” is configured and where an MPE prohibit timer (mpe-ProhibitTimer) is not running;
a case where, after last PHR transmission in a certain MAC entity, a measured value of PMPR applied to satisfy an MPE requirement for FR2 is greater than or equal to a certain threshold (mpe-Threshold) for at least one active serving cell in FR2; and
a case where, after last PHR transmission in a certain MAC entity, a measured value of PMPR applied to satisfy an MPE requirement for FR2 has changed more than a certain threshold (phr-Tx-PowerFactorChange (dB)), for at least one active serving cell in FR2. Note that, in the present case, the PHR may be referred to as an “MPE P-MPR report.”

### (Analysis)

### <Analysis 1>

As described above, it is studied that simultaneous multi-panel transmission (simultaneous multi-panel Tx (STxMP)) is applied to a PUSCH. For example, when STxMP is configured for a serving cell, an event/condition as a trigger of a PHR is unclear.

### <Analysis 2>

As a case where simultaneous multi-panel transmission is applied, a case of single DCI (S-DCI)/multi-DCI (M-DCI) is assumed. Particularly in the case of multi-DCI, considering a non-ideal backhaul, reports of PHRs for two TRPs can be present in separate MAC CEs. In this case, it is unclear whether the UE can separately transmit PHRs for the two TRPs.

Accordingly, unless a control method related to a PHR is clear, appropriate transmission control may fail, which may reduce communication throughput.

In view of this, the inventors of the present invention came up with the idea of a PHR control method depending on a scenario to be applied.

Embodiments according to the present disclosure will be described in detail with reference to the drawings as follows. The radio communication methods according to respective embodiments may each be employed individually, or may be employed in combination.

### (Various Interpretations and so on)

In the present disclosure, “A/B” and “at least one of A and B” may be interchangeably interpreted. In the present disclosure, “A/B/C” may mean “at least one of A, B, and C.”

In the present disclosure, notify, activate, deactivate, indicate, select, configure, update, determine, and the like may be interchangeably interpreted. In the present disclosure, “support,” “control,” “controllable,” “operate,” “operable,” and the like may be interchangeably interpreted.

In the present disclosure, radio resource control (RRC), an RRC parameter, an RRC message, a higher layer parameter, a field, an information element (IE), a configuration, and the like may be interchangeably interpreted. In the present disclosure, a Medium Access Control control element (MAC Control Element (CE)), an update command, an activation/deactivation command, and the like may be interchangeably interpreted.

In the present disclosure, the higher layer signaling may be, for example, any one or combinations of Radio Resource Control (RRC) signaling, Medium Access Control (MAC) signaling, broadcast information, another message (message from a core network, such as a positioning protocol (for example, NR Positioning Protocol A (NRPPa)/LTE Positioning Protocol (LPP)) message), and the like.

In the present disclosure, the MAC signaling may use, for example, a MAC control element (MAC CE), a MAC Protocol Data Unit (PDU), or the like. The broadcast information may be, for example, a master information block (MIB), a system information block (SIB), minimum system information (Remaining Minimum System Information (RMSI)), other system information (OSI), or the like.

In the present disclosure, the physical layer signaling may be, for example, downlink control information (DCI), uplink control information (UCI), or the like.

In the present disclosure, an index, an identifier (ID), an indicator, a resource ID, and the like may be interchangeably interpreted. In the present disclosure, a sequence, a list, a set, a group, a cluster, a subset, and the like may be interchangeably interpreted.

In the present disclosure, a panel, a UE panel, a panel group, a beam, a beam group, a precoder, an Uplink (UL) transmission entity, a transmission/reception point (TRP), a base station, spatial relation information (SRI), a spatial relation, an SRS resource indicator (SRI), a control resource set (CORESET), a Physical Downlink Shared Channel (PDSCH), a codeword (CW), a transport block (TB), a reference signal (RS), an antenna port (for example, a demodulation reference signal (DMRS) port), an antenna port group (for example, a DMRS port group), a group (for example, a spatial relation group, a code division multiplexing (CDM) group, a reference signal group, a CORESET group, a Physical Uplink Control Channel (PUCCH) group, a PUCCH resource group), a resource (for example, a reference signal resource, an SRS resource), a resource set (for example, a reference signal resource set), a CORESET pool, a downlink Transmission Configuration Indication state (TCI state) (DL TCI state), an uplink TCI state (UL TCI state), a unified TCI state, a common TCI state, quasi-co-location (QCL), QCL assumption, and the like may be interchangeably interpreted.

A spatial relation information Identifier (ID) (TCI state ID) and spatial relation information (TCI state) may be interchangeably interpreted. “Spatial relation information” may be interchangeably interpreted as “a set of spatial relation information”, “one or a plurality of pieces of spatial relation information”, and the like. The TCI state and the TCI may be interchangeably interpreted.

A spatial relation information Identifier (ID) (TCI state ID) and spatial relation information (TCI state) may be interchangeably interpreted. “Spatial relation information” may be interchangeably interpreted as “a set of spatial relation information”, “one or a plurality of pieces of spatial relation information”, and the like. The TCI state and the TCI may be interchangeably interpreted.

In the present disclosure, multi-panel simultaneous transmission (simultaneous multi-panel transmission) and multi-panel simultaneous UL transmission (simultaneous multi-panel UL transmission) may be interchangeably interpreted. In the present disclosure, to support and to be configured/indicated may be interchangeably interpreted. In the present disclosure, a loop, a power control loop, a power control loop index, a closed loop, an open loop, and a power control adjustment state may be interchangeably interpreted. In the present disclosure, transmission power and output power may be interchangeably interpreted.

Power limitation of the present disclosure may mean limitation based on maximum transmission power. A PHR of the present disclosure may, when not being particularly limited, mean an actual PHR, a virtual PHR, or both an actual PHR and a virtual PHR. p and q of the present disclosure may each mean a panel index.

In the present disclosure, multi-TRP (MTRP, M-TRP), a multi-TRP system, multi-TRP transmission, and multi-PDSCH may be interchangeably interpreted.

In the present disclosure, a “PHR,” a “PH,” a “PH field,” a “PH value,” and the like may be interchangeably interpreted. In the present disclosure, a PH field may be interpreted as a PH field of a certain type (for example, type 1/2/3/X), and vice versa.

Note that, in the present disclosure, a PHR MAC CE may include fields (PCMAX fields, P fields, and the like) for a plurality of respective serving cells.

In the present disclosure, a “PCMAX field/P-MPR value/power-backoff of (/for/corresponding to) a PH field” may be interpreted as a “PCMAX field/P-MPR value/power-backoff in (/for/corresponding to) corresponding PUSCH transmission with a PH field,” and vice versa.

In the present disclosure, P-MPR, a P-MPR value, and power backoff may be interchangeably interpreted.

In the present disclosure, UL transmission (UL Tx)/PHR associated with a panel and UL transmission (UL Tx)/PHR associated with a TRP may be interchangeably interpreted.

### (Radio Communication Method)

### First Embodiment

A first embodiment corresponds to Analysis 1, and relates to an event/condition for triggering a PHR in simultaneous multi-panel PUSCH transmission.

In the present disclosure, the respective schemes described above can be applied to a scheme for simultaneous multi-panel PUSCH transmission. In the description below, a different scheme may be applied for each option. Which scheme is to be applied for each option may be predefined by a specification, may be configured by higher layer signaling, or may be reported depending on a UE capability.

For example, for single-DCI based simultaneous multi-panel transmission, the same scheme as that for single-DCI based multi-TRP repetition transmission (repetition) may be applied to a PHR trigger/report (transmission) method. In the single-DCI based simultaneous multi-panel transmission, an ideal backhaul is considered, and thus single DCI schedules UL transmission for both (each) of multi-TRP. Accordingly, the same scheme as that for the single-DCI based multi-TRP repetition transmission (repetition) can be employed.

On the other hand, for multi-DCI based simultaneous multi-panel transmission, a dedicated PHR trigger/report (transmission) method may be applied. In the multi-DCI based simultaneous multi-panel transmission, a non-ideal backhaul is considered, and thus UL transmission corresponding to each TRP is scheduled by DCI corresponding to each TRP. Accordingly, a PHR specific to each TRP can be required. In other words, triggering/reporting (transmission) of a PHR for each TRP may be supported.

In the present disclosure, a serving cell being configured with simultaneous multi-panel PUSCH transmission, a serving cell being configured with two codebook (CB)/non-codebook (NCB) SRS resource sets, and a serving cell being configured with a certain higher layer parameter may be interchangeably interpreted.

An event/condition for triggering a PHR for a serving cell may be at least one of Options 1 to 2 below. In particular, Option 1 may be suitable for single-DCI based simultaneous multi-panel transmission, and Option 2 may be applied to multi-DCI based simultaneous multi-panel transmission. Application of Option 1/Option 2 may be switched based on higher layer signaling/physical layer signaling.

### [Option 1]

In Option 1, a condition for triggering a PHR for each serving cell will be described. A PHR is triggered when a specific event occurs in a serving cell. A PHR trigger condition/event in a serving cell configured with simultaneous multi-panel PUSCH transmission may be at least one of the following.

### <Option 1.1>

Option 1.1 relates to a PHR prohibit timer (phr-prohibitTimer).
Alt. 1: phr-prohibitTimer may be configured for each serving cell. A PHR may be triggered when phr-ProhibitTimer for the serving cell expired/has expired.
Alt. 2: phr-prohibitTimer may be configured for each panel/TRP.
Alt. 2-1: a PHR may be triggered when all the (for example, two) Phr-ProhibitTimers for respective panels/TRPs configured for the serving cell expired/have expired.
Alt. 2-2: a PHR may be triggered when phr-ProhibitTimer for any one panel/TRP of two panels/TRPs configured for the serving cell expired/has expired.
Alt. 2-3: a PHR may be triggered when phr-ProhibitTimer for one specific panel/TRP (for example, the first panel/TRP) of two panels/TRPs configured for the serving cell expired/has expired.

### <Option 1.2>

### Option 1.2 Relates to a Pass Loss (Change).

Alt. 1: a PHR may be triggered when, in both (two) panels/TRPs/reference signals for the serving cell, a pass loss has changed more than a certain threshold (phr-Tx-PowerFactorChange).
Alt. 2: a PHR may be triggered when, in any one panel/TRP/reference signal of two panels/TRPs/reference signals corresponding to the serving cell, a pass loss has changed more than a certain threshold (phr-Tx-PowerFactorChange).
Alt. 3: a PHR may be triggered when, in one specific panel/TRP/reference signal (for example, the first panel/TRP/reference signal) of two panels/TRPs/reference signals corresponding to the serving cell, a pass loss has changed more than a certain threshold (phr-Tx-PowerFactorChange).

Variation: the certain threshold (phr-Tx-PowerFactorChange) may be configured for each panel/TRP/reference signal.

### <Option 1.3>

### Option 1.3 Relates to a PHR Periodic Timer (Phr-PeriodicTimer).

Alt. 1: phr-PeriodicTimer may be configured for each serving cell. A PHR may be triggered when phr-PeriodicTimer for the serving cell expired/has expired.
Alt. 2: phr-PeriodicTimer may be configured for each panel/TRP.
Alt. 2-1: a PHR may be triggered when all the (for example, two) phr-PeriodicTimers for respective panels/TRPs configured for the serving cell expired/have expired.
Alt. 2-2: a PHR may be triggered when phr-PeriodicTimer for any one panel/TRP of two panels/TRPs configured for the serving cell expired/has expired.
Alt. 2-3: a PHR may be triggered when phr-PeriodicTimer for one specific panel/TRP (for example, the first panel/TRP) of two panels/TRPs configured for the serving cell expired/has expired.

### <Option 1.4>

### Option 1.4 Relates to Power-Management Maximum Power Reduction (PMPR) (Change).

Alt. 1: PMPR may be configured for each serving cell. A PHR may be triggered when requested power backoff based on power management for the serving cell (permitted by PMPR defined in a specification and corresponding to a certain serving cell) has changed more than a certain threshold (phr-Tx-PowerFactorChange).
Alt. 2: PMPR may be configured for each panel/TRP.
Alt. 2-1: a PHR may be triggered when, in both two panels/TRPs corresponding to the serving cell, requested power backoff based on the power management for the serving cell has changed more than a certain threshold (phr-Tx-PowerFactorChange).
Alt. 2-2: a PHR may be triggered when, in any one panel/TRP of two panels/TRPs corresponding to the serving cell, requested power backoff based on the power management for the serving cell has changed more than a certain threshold (phr-Tx-PowerFactorChange).
Alt. 2-3: a PHR may be triggered when, in one specific panel/TRP (for example, a first panel/TRP) of two panels/TRPs corresponding to the serving cell, requested power backoff based on the power management for the serving cell has changed more than a certain threshold (phr-Tx-PowerFactorChange).

Variation: the certain threshold (phr-Tx-PowerFactorChange) may be configured for each panel/TRP.

### <Option 1.5>

Option 1.5 relates to an MPE prohibit timer (mpe-ProhibitTimer). When mpe-Reporting-FR2 is configured, at least one of the following conditions may be applied.
Alt. 1: mpe-ProhibitTimer may be configured for each serving cell. A PHR may be triggered when mpe-ProhibitTimer for the serving cell is not running.
Alt. 2: mpe-ProhibitTimer may be configured for each panel/TRP.
Alt. 2-1: a PHR may be triggered when all the (for example, two) mpe-ProhibitTimers for respective panels/TRPs configured for the serving cell are not running.
Alt. 2-2: a PHR may be triggered when mpe-ProhibitTimer for any one panel/TRP of two panels/TRPs configured for the serving cell is not running.
Alt. 2-3: a PHR may be triggered when mpe-ProhibitTimer for one specific panel/TRP (for example, the first panel/TRP) of two panels/TRPs configured for the serving cell is not running.

### <Option 1.6>

Option 1.6 relates to PMPR for FR2 MPE. When mpe-Reporting-FR2 is configured, at least one of the following conditions may be applied.
Alt. 1: PMPR may be configured for each serving cell. A PHR may be triggered when a measured value of PMPR applied to satisfy an FR2 MPE requirement defined in a specification is greater than or equal to a certain threshold (mpe-Threshold).
Alt. 2: PMPR may be configured for each panel/TRP.
Alt. 2-1: a PHR may be triggered when, in both two panels/TRPs corresponding to the serving cell, a measured value of the PMPR is greater than or equal to a certain threshold (mpe-Threshold).
Alt. 2-2: a PHR may be triggered when, in any one panel/TRP of two panels/TRPs corresponding to the serving cell, a measured value of the PMPR is greater than or equal to a certain threshold (mpe-Threshold).
Alt. 2-3: a PHR may be triggered when, in one specific panel/TRP (for example, a first panel/TRP) of two panels/TRPs corresponding to the serving cell, a measured value of the PMPR is greater than or equal to a certain threshold (mpe-Threshold).

Variation: the certain threshold (mpe-Threshold) may be configured for each panel/TRP.

### <Option 1.7>

Option 1.7 relates to PMPR (change) for FR2 MPE. When mpe-Reporting-FR2 is configured, at least one of the following conditions may be applied.
Alt. 1: PMPR may be configured for each serving cell. A PHR may be triggered when a measured value of PMPR applied to satisfy an FR2 MPE requirement defined in a specification has changed more than a certain threshold (phr-Tx-PowerFactorChange).
Alt. 2: PMPR may be configured for each panel/TRP.
Alt. 2-1: a PHR may be triggered when, in both two panels/TRPs corresponding to the serving cell, a measured value of the PMPR has changed more than a certain threshold (phr-Tx-PowerFactorChange).
Alt. 2-2: a PHR may be triggered when, in any one panel/TRP of two panels/TRPs corresponding to the serving cell, a measured value of the PMPR has changed more than a certain threshold (phr-Tx-PowerFactorChange).
Alt. 2-3: a PHR may be triggered when, in one specific panel/TRP (for example, a first panel/TRP) of two panels/TRPs corresponding to the serving cell, a measured value of the PMPR has changed more than a certain threshold (phr-Tx-PowerFactorChange).

Variation: the certain threshold (phr-Tx-PowerFactorChange) may be configured for each panel/TRP.

### [Option 2]

In Option 2, a condition for triggering a PHR for each panel/TRP for a serving cell will be described. A PHR is triggered when a specific event occurs in a certain panel/TRP for a serving cell. A PHR trigger condition/event in a panel/TRP for a serving cell configured with simultaneous multi-panel PUSCH transmission may be at least one of the following.
Alt. 1: phr-prohibitTimer may be configured for each panel/TRP. A PHR may be triggered when phr-ProhibitTimer configured for the panel/TRP expired/has expired.
Alt. 2: a PHR may be triggered when a pass loss has changed more than a certain threshold (phr-Tx-PowerFactorChange) corresponding to the panel/TRP.

Variation: phr-Tx-PowerFactorChange may be configured for each panel/TRP.
Alt. 3: phr-PeriodicTimer may be configured for each panel/TRP. A PHR may be triggered when phr-PeriodicTimer configured for the panel/TRP expired/has expired.
Alt. 4: PMPR may be configured for each panel/TRP. A PHR may be triggered when requested power backoff based on power management for the panel/TRP has changed more than a certain threshold (phr-Tx-Power FactorChange).

Variation: phr-Tx-PowerFactorChange may be configured for each panel/TRP.
Alt. 5: when mpe-Reporting-FR2 is configured.
mpe-ProhibitTimer may be configured for each panel/TRP. A PHR may be triggered when mpe-ProhibitTimer configured for each panel/TRP is not running.
Alt. 6: when mpe-Reporting-FR2 is configured.
PMPR may be configured for each panel/TRP. A PHR may be triggered when a measured value of PMPR applied to satisfy an FR2 MPE requirement defined in a specification is greater than or equal to a certain threshold (mpe-Threshold).
Variation: mpe-Threshold may be configured for each panel/TRP.
Alt. 7: when mpe-Reporting-FR2 is configured.
A PHR may be triggered when a measured value of the PMPR has changed more than a certain threshold (phr-Tx-PowerFactorChange). Variation: the certain threshold (phr-Tx-PowerFactorChange) may be configured for each panel/TRP.

The first embodiment described above allows a UE to appropriately control execution (triggering) of a PHR in simultaneous multi-panel PUSCH transmission.

### Second Embodiment

A second embodiment corresponds to Analysis 2, relates to multi-DCI based simultaneous multi-panel transmission, and particularly describes a MAC CE for PHR.

In the present disclosure, the respective schemes described above can be applied to a scheme for simultaneous multi-panel PUSCH transmission. For example, when multi-DCI based simultaneous multi-panel PUSCH transmission is configured for a serving cell, Scheme 5 described above may be applied.

In the present disclosure, a serving cell being configured with multi-DCI based simultaneous multi-panel PUSCH transmission, a serving cell being configured with two codebook (CB)/non-codebook (NCB) SRS resource sets, a serving cell being configured with two CORESETPoolIndices being associated with two codebook (CB)/non-codebook (NCB) SRS resource sets, and a serving cell being configured with a certain higher layer parameter may be interchangeably interpreted.

In the present disclosure, a MAC CE for PHR, a PHR MAC CE, a single entry PHR MAC CE, and a MAC CE may be interchangeably interpreted.

### Embodiment 2.1

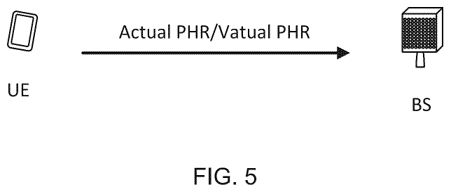

Embodiment 2.1 describes a specific example of the MAC CE for PHR (PHR MAC CE). FIG. 5 is a diagram to show an outline of PHR transmission. When simultaneous uplink (UL) transmission from multi-panel is supported, a UE may receive a configuration of limitation related to transmission power per panel/cell. As shown in FIG. 5, the UE controls, based on the configuration, transmission (reporting) of at least one of a power headroom (PHR) based on actual PUSCH transmission (first PHR/actual PHR) and a PHR independent of the actual PUSCH transmission (second PHR/virtual PHR). The limitation may be maximum UL transmission power, and may be, for example, maximum UL transmission power per panel. The UE may determine the maximum UL transmission power, based on a capability. At least one of the first PHR and the second PHR may be based on single-panel transmission.

The PHR may be transmitted by MAC signaling using a PUSCH. For example, the PHR may be notified by using a PHR MAC CE (Control Element) included in a MAC PDU.

NR supports a single entry PHR MAC CE related to a primary cell (PCell).

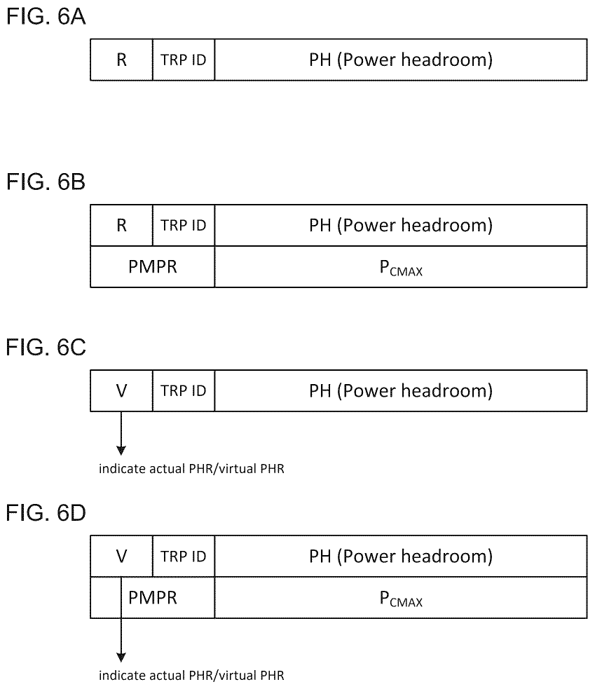

FIGS. 6A to 6D are examples to show the MAC CE for PHR according to the second embodiment. One MAC CE (single entry PHR MAC CE) may include a PHR corresponding to one panel/TRP for a serving cell. Which panel/TRP the one MAC CE includes a PHR for can be identified by a different logical channel ID (LCID) or indication of a field of the MAC CE. The numbers of bits of respective fields described below are merely examples.

As shown in FIG. 6A, the MAC CE may be constituted by one octet (=8 bits). ‘R’ indicates a 1-bit reserved field, and is set to a ‘0’ value, for example. ‘TRP ID’ indicates a 1-bit field, and is set to a ‘0’/‘1’ value, for example.

‘PH (power headroom)’ may indicate a 6-bit field. The field may indicate an index related to PH for a certain serving cell. As described in FIGS. 3 and 4 and the like, the field may indicate an index related to PH for each type of a certain cell (for example, a PCell/SpCell), for example. The index related to the PH may be associated with a specific PH value (decibel (dB) unit) (or level).

As shown in FIG. 6B, the MAC CE may be constituted by two octets (=16 bits). The MAC CE may further include a field related to PMPR/P_{CMAX}.

‘PMPR’ of FIG. 6B may indicate a 2-bit field. The field may be a field related to power management maximum power reduction (P-MPR) for serving cell c. ‘P_{CMAX}’ may indicate a 6-bit field. The field may indicate an index related to P_{CMAX,f,c} used for calculation of the above-described PH field. The index related to P_{CMAX,f,c} is associated with a specific UE transmission power level (dB). Note that P_{CMAX,f,c} may be referred to as configured UE maximum transmission power (maximum permitted transmission power) for serving cell c of carrier f. In the present disclosure, P_{CMAX,f,c} may be simply expressed as P_{CMAX}, PCMAX, or the like.

As shown in FIGS. 6C to 6D, the MAC CE may include a ‘V’ field in place of an ‘R’ field. ‘V’ may indicate a 1-bit field. The field is a field indicating that a PHR to be reported is an actual PHR/virtual PHR. For example, the field may, when being set to a value of ‘0,’ indicate that a PHR to be reported is an actual PHR, and may, when being set to a value of ‘1,’ indicate that a PHR to be reported is a virtual PHR.

Note that the MAC CE shown in FIG. 6 is merely an example, and can be appropriately interpreted as the MAC CE of each of FIGS. 3 and 4 described above.

### Embodiment 2.2

Embodiment 2.2 describes a condition for transmission of the above-described PHR MAC CE.

When, for a serving cell, the above-described one MAC CE includes a PHR corresponding to one/two panels/TRPs, the UE may control transmission of the MAC CE, based on the following conditions. A condition in a case where one MAC CE includes a PHR corresponding to one panel/TRP and a condition in a case where one MAC CE includes a PHR corresponding to two panels/TRPs will be described below in Option 1 and Option 2, respectively.

### <Option 1>

When, for a certain serving cell, one MAC CE includes a PHR corresponding to one panel/TRP (TRP #X), the UE may control transmission of the MAC CE, based on at least one of the following conditions. In other words, transmission of the MAC CE may be controlled based on at least one of the following conditions.
The MAC CE may be transmitted to the corresponding TRP (TRP #X) when a MAC entity includes a UL resource associated with the corresponding TRP (TRP #X).
Transmission of the MAC CE may be controlled in accordance with any one of Alt. 1 to Alt. 3 below when a MAC entity includes a UL resource associated with the corresponding TRP (TRP #X) and includes a UL resource associated with another TRP (TRP #Y).
Alt. 1: the MAC CE is transmitted only to the corresponding TRP (TRP #X).
Alt. 2: the MAC CE is transmitted to the corresponding TRP (TRP #X), and is also transmitted to another TRP (TRP #Y).
Alt. 3: whether the MAC CE is transmitted to either of the TRPs or both of the TRPs may depend on UE implementation.
Transmission of the MAC CE may be controlled in accordance with any one of Alt. 1 to Alt. 3 below when a MAC entity includes a UL resource associated with another TRP (TRP #Y).
Alt. 1: the MAC CE is transmitted (only) to another TRP (TRP #Y).
Alt. 2: the MAC CE is not transmitted.
Alt. 3: whether the MAC CE is transmitted may depend on UE implementation.

### <Option 2>

When, for a certain serving cell, one MAC CE includes a PHR corresponding to two panels/TRPs (TRPs #X), the UE may control transmission of the MAC CE, based on at least one of the following conditions. In other words, transmission of the MAC CE may be controlled based on at least one of the following conditions.
Transmission of the MAC CE may be controlled in accordance with any one of Alt. 1 to Alt. 4 below when a MAC entity includes a UL resource associated with both (two) TRPs (TRPs #X and #Y).
Alt. 1: the MAC CE is transmitted only to one TRP (any one of TRPs #X and #Y). Which TRP the MAC CE is transmitted to may depend on UE implementation.
Alt. 2: the MAC CE is transmitted only to one TRP (any one of TRPs #X and #Y). Which TRP the MAC CE is transmitted to may be selected by a certain rule (definition by a specification)/network configuration (configuration/indication by higher layer signaling/physical layer signaling).
Alt. 3: the MAC CE is transmitted to both (two) TRPs (TRPs #X and #Y).
Alt. 4: whether the MAC CE is transmitted to either of the TRPs (any one of TRPs #X and #Y) or both of the TRPs (TRPs #X and #Y) may depend on UE implementation.

The second embodiment described above allows a UE to appropriately transmit/report a PHR by using a MAC CE.

### <Supplements>

### {Notification of Information to UE}

Notification of any information to a UE (from a network (NW) (for example, a base station (BS))) (in other words, reception of any information from the BS in the UE) in the above-described embodiments may be performed by using physical layer signaling (for example, DCI), higher layer signaling (for example, RRC signaling, MAC CE), a specific signal/channel (for example, a PDCCH, a PDSCH, a reference signal), or a combination of these.

When the notification is performed by a MAC CE, the MAC CE may be identified by a new logical channel ID (LCID) not defined in an existing standard being included in a MAC subheader.

When the notification is performed by DCI, the notification may be performed by a specific field of the DCI, a radio network temporary identifier (RNTI) used for scrambling of cyclic redundancy check (CRC) bits given to the DCI, a format of the DCI, or the like.

Notification of any information to a UE in the above-described embodiments may be performed periodically, semi-persistently, or aperiodically.

{Notification of Information from UE}

Notification of any information from a UE (to an NW) (in other words, transmission/reporting of any information to the BS from the UE) in the above-described embodiments may be performed by using physical layer signaling (for example, UCI), higher layer signaling (for example, RRC signaling, MAC CE), a specific signal/channel (for example, a PUCCH, a PUSCH, a PRACH, a reference signal), or a combination of these.

When the notification is performed by a MAC CE, the MAC CE may be identified by a new LCID not defined in existing standards being included in a MAC subheader.

When the notification is performed by UCI, the notification may be transmitted by using a PUCCH or a PUSCH.

Notification of any information from a UE in the above-described embodiments may be performed periodically, semi-persistently, or aperiodically.

### {Regarding Application of Each Embodiment}

At least one of the above-described embodiments may be applied to a case satisfying a specific condition. The specific condition may be defined in a standard, or a UE/BS may be notified of the specific condition by using higher layer signaling/physical layer signaling.

At least one of the above-described embodiments may be applied only to a UE that has reported a specific UE capability or that supports the specific UE capability.

The specific UE capability may indicate at least one of the following:
support of specific processing/operation/control/information for at least one of the embodiments above
simultaneous multi-panel transmission/reception being supported by the UE
reporting/transmission of a PHR related to simultaneous multi-panel transmission/reception being supported by the UE
per-panel power limitation or per-cell power limitation being supported by the UE for simultaneous multi-panel transmission
per-panel power limitation or per-cell power limitation being supported by the UE for single-panel transmission (when simultaneous multi-panel transmission is supported)
reporting of two PHRs for two panels being supported by the UE for one serving cell

The specific UE capability may be capability applied over all the frequencies (commonly irrespective of frequency), capability per frequency (for example, one or a combination of cell, band, band combination, BWP, component carrier, and the like), capability per frequency range (for example, Frequency Range 1 (FR1), FR2, FR3, FR4, FR5, FR2-1, FR2-2), capability per subcarrier spacing (SCS), or capability per Feature Set (FS) or Feature Set Per Component-carrier (FSPC).

The specific UE capability may be capability applied over all the duplex schemes (commonly irrespective of duplex scheme) or capability per duplex scheme (for example, time division duplex (TDD) or frequency division duplex (FDD)).

At least one of the above-described embodiments may be applied when the UE is configured/activated/triggered with specific information related to the above-described embodiment (or performance of the operation of the above-described embodiment) by higher layer signaling/physical layer signaling. For example, the specific information may be information indicating enabling of reporting/transmission of a PHR (triggering of a PHR), any RRC parameter for a specific release (for example, Rel. 18/19), or the like.

When the UE does not support at least one of the specific UE capabilities above and is not configured with the specific information, operation of Rel. 15/16 may be applied, for example.

### (Supplementary Note)

Regarding one embodiment (first embodiment) of the present disclosure, the following supplementary notes of the invention will be given.

### {Supplementary Note 1}

A terminal including:
a transmitting section that transmits a physical uplink shared channel (PUSCH) by using simultaneous uplink (UL) transmission from multi-panel; and
a control section that controls triggering of a power headroom (PHR) based on the PUSCH transmission, based on a specific condition.

### {Supplementary Note 2}

The terminal according to supplementary note 1, wherein the specific condition relates to a prohibit timer for the PHR or maximum permitted exposure (MPE).

### {Supplementary Note 3}

The terminal according to supplementary note 1 or 2, wherein the specific condition relates to a change in a path loss or power management maximum power reduction (PMPR) of a corresponding reference signal.

### {Supplementary Note 4}

The terminal according to any one of supplementary notes 1 to 3, wherein the control section controls triggering of the PHR for each serving cell or each panel.

### (Supplementary Note)

Regarding one embodiment (second embodiment) of the present disclosure, the following supplementary notes of the invention will be given.

### {Supplementary Note 1}

A terminal including:
a transmitting section that, when simultaneous uplink (UL) transmission from multi-panel is supported, transmits a Medium Access Control Control Element (MAC CE) including a power headroom (PHR) per serving cell or per panel; and
a control section that controls transmission of the MAC CE, based on a specific condition.

### {Supplementary Note 2}

The terminal according to supplementary note 1, wherein the MAC CE includes at least one of a field related to maximum power and a field indicating an actual PHR or a virtual PHR.

### {Supplementary Note 3}

The terminal according to supplementary note 1 or 2, wherein
the specific condition is based on presence or absence of a UL resource associated with a corresponding panel.

### {Supplementary Note 4}

The terminal according to any one of supplementary notes 1 to 3, wherein
the control section judges, based on presence or absence of a UL resource associated with a corresponding panel, a panel to which the MAC CE is transmitted.

### (Radio Communication System)

Hereinafter, a structure of a radio communication system according to one embodiment of the present disclosure will be described. In this radio communication system, the radio communication method according to each embodiment of the present disclosure described above may be used alone or may be used in combination for communication.

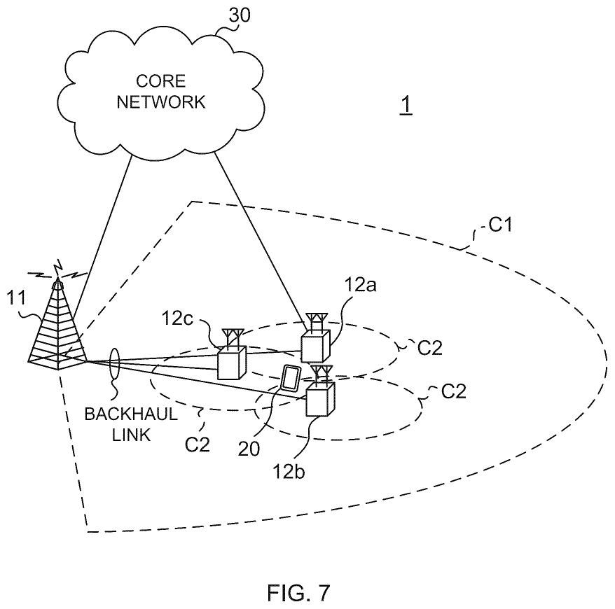

FIG. 7 is a diagram to show an example of a schematic structure of the radio communication system according to one embodiment. The radio communication system 1 (which may be simply referred to as a system 1) may be a system implementing a communication using Long Term Evolution (LTE), 5th generation mobile communication system New Radio (5G NR) and so on the specifications of which have been drafted by Third Generation Partnership Project (3GPP).

The radio communication system 1 may support dual connectivity (multi-RAT dual connectivity (MR-DC)) between a plurality of Radio Access Technologies (RATs). The MR-DC may include dual connectivity (E-UTRA-NR Dual Connectivity (EN-DC)) between LTE (Evolved Universal Terrestrial Radio Access (E-UTRA)) and NR, dual connectivity (NR-E-UTRA Dual Connectivity (NE-DC)) between NR and LTE, and so on.

In EN-DC, a base station (eNB) of LTE (E-UTRA) is a master node (MN), and a base station (gNB) of NR is a secondary node (SN). In NE-DC, a base station (gNB) of NR is an MN, and a base station (eNB) of LTE (E-UTRA) is an SN.

The radio communication system 1 may support dual connectivity between a plurality of base stations in the same RAT (for example, dual connectivity (NR-NR Dual Connectivity (NN-DC)) where both of an MN and an SN are base stations (gNB) of NR).

The radio communication system 1 may include a base station 11 that forms a macro cell C1 of a relatively wide coverage, and base stations 12 (12a to 12c) that form small cells C2, which are placed within the macro cell C1 and which are narrower than the macro cell C1. The user terminal 20 may be located in at least one cell. The arrangement, the number, and the like of each cell and user terminal 20 are by no means limited to the aspect shown in the diagram. Hereinafter, the base stations 11 and 12 will be collectively referred to as “base stations 10,” unless specified otherwise.

The user terminal 20 may be connected to at least one of the plurality of base stations 10. The user terminal 20 may use at least one of carrier aggregation (CA) and dual connectivity (DC) using a plurality of component carriers (CCs).

Each CC may be included in at least one of a first frequency band (Frequency Range 1 (FR1)) and a second frequency band (Frequency Range 2 (FR2)). The macro cell C1 may be included in FR1, and the small cells C2 may be included in FR2. For example, FR1 may be a frequency band of 6 GHz or less (sub-6 GHZ), and FR2 may be a frequency band which is higher than 24 GHZ (above-24 GHz). Note that frequency bands, definitions and so on of FR1 and FR2 are by no means limited to these, and for example, FR1 may correspond to a frequency band which is higher than FR2.

The user terminal 20 may communicate using at least one of time division duplex (TDD) and frequency division duplex (FDD) in each CC.

The plurality of base stations 10 may be connected by a wired connection (for example, optical fiber in compliance with the Common Public Radio Interface (CPRI), the X2 interface and so on) or a wireless connection (for example, an NR communication). For example, if an NR communication is used as a backhaul between the base stations 11 and 12, the base station 11 corresponding to a higher station may be referred to as an “Integrated Access Backhaul (IAB) donor,” and the base station 12 corresponding to a relay station (relay) may be referred to as an “IAB node.”

The base station 10 may be connected to a core network 30 through another base station 10 or directly. For example, the core network 30 may include at least one of Evolved Packet Core (EPC), 5G Core Network (5GCN), Next Generation Core (NGC), and so on.

The core network 30 may include network functions (NF) such as a User Plane Function (UPF), an Access and Mobility management Function (AMF), a Session Management Function (SMF), Unified Data Management (UDM), an Application Function (AF), a Data Network (DN), a Location Management Function (LMF), and operation, administration, and maintenance (Management) (OAM). Note that a plurality of functions may be provided by one network node. Communication with an external network (for example, the Internet) may be performed via the DN.

The user terminal 20 may be a terminal supporting at least one of communication schemes such as LTE, LTE-A, 5G, and so on.

In the radio communication system 1, an orthogonal frequency division multiplexing (OFDM)-based wireless access scheme may be used. For example, in at least one of the downlink (DL) and the uplink (UL), Cyclic Prefix OFDM (CP-OFDM), Discrete Fourier Transform Spread OFDM (DFT-S-OFDM), Orthogonal Frequency Division Multiple Access (OFDMA), Single Carrier Frequency Division Multiple Access (SC-FDMA), and so on may be used.

The wireless access scheme may be referred to as a “waveform.” Note that, in the radio communication system 1, another wireless access scheme (for example, another single carrier transmission scheme, another multi-carrier transmission scheme) may be used for a wireless access scheme in the UL and the DL.

In the radio communication system 1, a downlink shared channel (Physical Downlink Shared Channel (PDSCH)), which is used by each user terminal 20 on a shared basis, a broadcast channel (Physical Broadcast Channel (PBCH)), a downlink control channel (Physical Downlink Control Channel (PDCCH)) and so on, may be used as downlink channels.

In the radio communication system 1, an uplink shared channel (Physical Uplink Shared Channel (PUSCH)), which is used by each user terminal 20 on a shared basis, an uplink control channel (Physical Uplink Control Channel (PUCCH)), a random access channel (Physical Random Access Channel (PRACH)) and so on may be used as uplink channels.

User data, higher layer control information, System Information Blocks (SIBs) and so on are communicated on the PDSCH. User data, higher layer control information and so on may be communicated on the PUSCH. The Master Information Blocks (MIBs) may be communicated on the PBCH.

Lower layer control information may be communicated on the PDCCH. For example, the lower layer control information may include downlink control information (DCI) including scheduling information of at least one of the PDSCH and the PUSCH.

Note that DCI for scheduling the PDSCH may be referred to as “DL assignment,” “DL DCI,” and so on, and DCI for scheduling the PUSCH may be referred to as “UL grant,” “UL DCI,” and so on. Note that the PDSCH may be interpreted as “DL data”, and the PUSCH may be interpreted as “UL data”.

For detection of the PDCCH, a control resource set (CORESET) and a search space may be used. The CORESET corresponds to a resource to search DCI. The search space corresponds to a search area and a search method of PDCCH candidates. One CORESET may be associated with one or more search spaces. The UE may monitor a CORESET associated with a certain search space, based on search space configuration.

One search space may correspond to a PDCCH candidate corresponding to one or more aggregation levels. One or more search spaces may be referred to as a “search space set.” Note that a “search space,” a “search space set,” a “search space configuration,” a “search space set configuration,” a “CORESET,” a “CORESET configuration” and so on of the present disclosure may be interchangeably interpreted.

Uplink control information (UCI) including at least one of channel state information (CSI), transmission confirmation information (for example, which may be referred to as Hybrid Automatic Repeat reQuest ACKnowledgement (HARQ-ACK), ACK/NACK, and so on), and scheduling request (SR) may be communicated by means of the PUCCH. By means of the PRACH, random access preambles for establishing connections with cells may be communicated.

Note that the downlink, the uplink, and so on in the present disclosure may be expressed without a term of “link.” In addition, various channels may be expressed without adding “Physical” to the head.

In the radio communication system 1, a synchronization signal (SS), a downlink reference signal (DL-RS), and so on may be communicated. In the radio communication system 1, a cell-specific reference signal (CRS), a channel state information-reference signal (CSI-RS), a demodulation reference signal (DMRS), a positioning reference signal (PRS), a phase tracking reference signal (PTRS), and so on may be communicated as the DL-RS.

For example, the synchronization signal may be at least one of a primary synchronization signal (PSS) and a secondary synchronization signal (SSS). A signal block including an SS (PSS, SSS) and a PBCH (and a DMRS for a PBCH) may be referred to as an “SS/PBCH block,” an “SS Block (SSB),” and so on. Note that an SS, an SSB, and so on may be referred to as a “reference signal.”

In the radio communication system 1, a sounding reference signal (SRS), a demodulation reference signal (DMRS), and so on may be communicated as an uplink reference signal (UL-RS). Note that DMRS may be referred to as a “user terminal specific reference signal (UE-specific Reference Signal).”

### (Base Station)

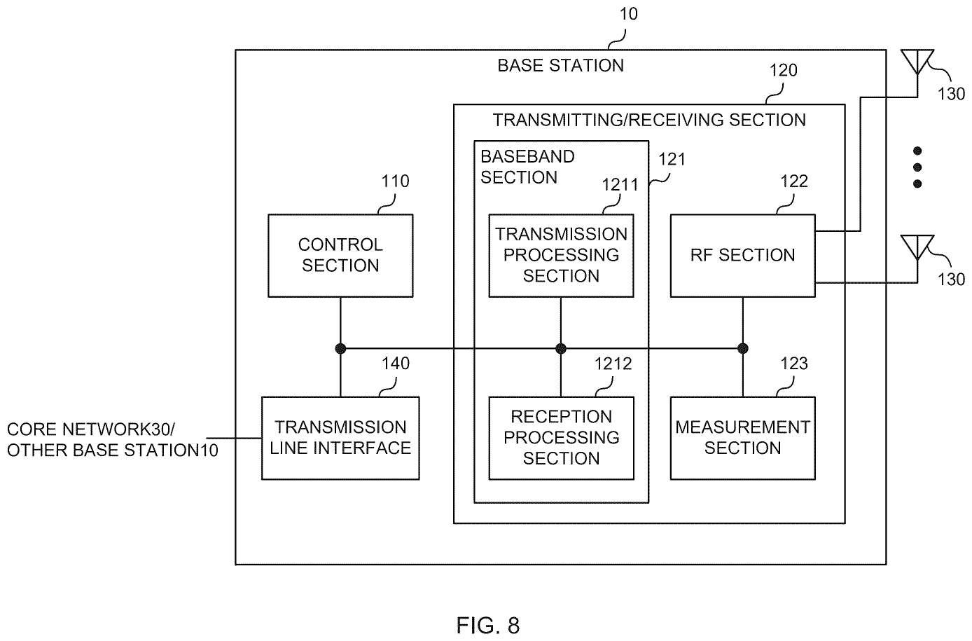

FIG. 8 is a diagram to show an example of a structure of the base station according to one embodiment. The base station 10 includes a control section 110, a transmitting/receiving section 120, transmitting/receiving antennas 130 and a communication path interface (transmission line interface) 140. Note that the base station 10 may include one or more control sections 110, one or more transmitting/receiving sections 120, one or more transmitting/receiving antennas 130, and one or more communication path interfaces 140.

Note that, the present example primarily shows functional blocks that pertain to characteristic parts of the present embodiment, and it is assumed that the base station 10 may include other functional blocks that are necessary for radio communication as well. Part of the processes of each section described below may be omitted.

The control section 110 controls the whole of the base station 10. The control section 110 can be constituted with a controller, a control circuit, or the like described based on general understanding of the technical field to which the present disclosure pertains.

The control section 110 may control generation of signals, scheduling (for example, resource allocation, mapping), and so on. The control section 110 may control transmission and reception, measurement and so on using the transmitting/receiving section 120, the transmitting/receiving antennas 130, and the communication path interface 140. The control section 110 may generate data, control information, a sequence and so on to transmit as a signal, and forward the generated items to the transmitting/receiving section 120. The control section 110 may perform call processing (setting up, releasing) for communication channels, manage the state of the base station 10, and manage the radio resources.

The transmitting/receiving section 120 may include a baseband section 121, a Radio Frequency (RF) section 122, and a measurement section 123. The baseband section 121 may include a transmission processing section 1211 and a reception processing section 1212. The transmitting/receiving section 120 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 120 may be structured as a transmitting/receiving section in one entity, or may be constituted with a transmitting section and a receiving section. The transmitting section may be constituted with the transmission processing section 1211, and the RF section 122. The receiving section may be constituted with the reception processing section 1212, the RF section 122, and the measurement section 123.

The transmitting/receiving antennas 130 can be constituted with antennas, for example, an array antenna, or the like described based on general understanding of the technical field to which the present disclosure pertains.

The transmitting/receiving section 120 may transmit the above-described downlink channel, synchronization signal, downlink reference signal, and so on. The transmitting/receiving section 120 may receive the above-described uplink channel, uplink reference signal, and so on.

The transmitting/receiving section 120 may form at least one of a transmit beam and a receive beam by using digital beam forming (for example, precoding), analog beam forming (for example, phase rotation), and so on.

The transmitting/receiving section 120 (transmission processing section 1211) may perform the processing of the Packet Data Convergence Protocol (PDCP) layer, the processing of the Radio Link Control (RLC) layer (for example, RLC retransmission control), the processing of the Medium Access Control (MAC) layer (for example, HARQ retransmission control), and so on, for example, on data and control information and so on acquired from the control section 110, and may generate bit string to transmit.

The transmitting/receiving section 120 (transmission processing section 1211) may perform transmission processing such as channel coding (which may include error correction coding), modulation, mapping, filtering, discrete Fourier transform (DFT) processing (as necessary), inverse fast Fourier transform (IFFT) processing, precoding, digital-to-analog conversion, and so on, on the bit string to transmit, and output a baseband signal.

The transmitting/receiving section 120 (RF section 122) may perform modulation to a radio frequency band, filtering, amplification, and so on, on the baseband signal, and transmit the signal of the radio frequency band through the transmitting/receiving antennas 130.

On the other hand, the transmitting/receiving section 120 (RF section 122) may perform amplification, filtering, demodulation to a baseband signal, and so on, on the signal of the radio frequency band received by the transmitting/receiving antennas 130.

The transmitting/receiving section 120 (reception processing section 1212) may apply reception processing such as analog-digital conversion, fast Fourier transform (FFT) processing, inverse discrete Fourier transform (IDFT) processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 120 (measurement section 123) may perform the measurement related to the received signal. For example, the measurement section 123 may perform Radio Resource Management (RRM) measurement, Channel State Information (CSI) measurement, and so on, based on the received signal. The measurement section 123 may measure a received power (for example, Reference Signal Received Power (RSRP)), a received quality (for example, Reference Signal Received Quality (RSRQ), a Signal to Interference plus Noise Ratio (SINR), a Signal to Noise Ratio (SNR)), a signal strength (for example, Received Signal Strength Indicator (RSSI)), channel information (for example, CSI), and so on. The measurement results may be output to the control section 110.

The communication path interface 140 may perform transmission/reception (backhaul signaling) of a signal with an apparatus included in the core network 30 (for example, a network node providing NF) or other base stations 10, and so on, and acquire or transmit user data (user plane data), control plane data, and so on for the user terminal 20.

Note that the transmitting section and the receiving section of the base station 10 in the present disclosure may be constituted with at least one of the transmitting/receiving section 120, the transmitting/receiving antennas 130, and the communication path interface 140.

Note that the transmitting/receiving section 120 may receive a physical uplink shared channel (PUSCH) transmitted from a terminal by using simultaneous uplink (UL) transmission from multi-panel. The transmitting/receiving section 120 may transmit configuration information for controlling triggering of a power headroom (PHR) based on the PUSCH transmission.

The transmitting/receiving section 120 may, when simultaneous uplink (UL) transmission from multi-panel is supported, receive a Medium Access Control Control Element (MAC CE) including a power headroom (PHR) per serving cell or per panel.

The control section 110 may control reception of the MAC CE judged by the terminal, based on a specific condition.

### (User Terminal)

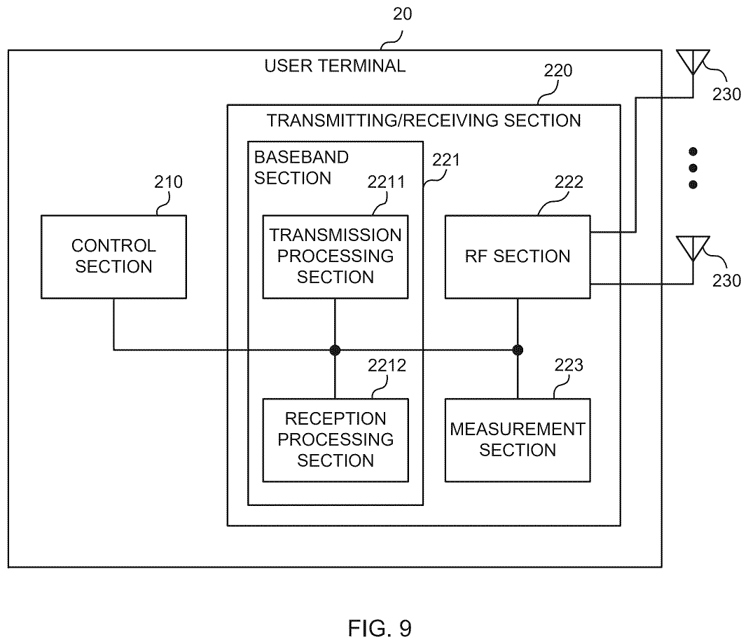

FIG. 9 is a diagram to show an example of a structure of the user terminal according to one embodiment. The user terminal 20 includes a control section 210, a transmitting/receiving section 220, and transmitting/receiving antennas 230. Note that the user terminal 20 may include one or more control sections 210, one or more transmitting/receiving sections 220, and one or more transmitting/receiving antennas 230.

Note that, the present example primarily shows functional blocks that pertain to characteristic parts of the present embodiment, and it is assumed that the user terminal 20 may include other functional blocks that are necessary for radio communication as well. Part of the processes of each section described below may be omitted.

The control section 210 controls the whole of the user terminal 20. The control section 210 can be constituted with a controller, a control circuit, or the like described based on general understanding of the technical field to which the present disclosure pertains.

The control section 210 may control generation of signals, mapping, and so on. The control section 210 may control transmission/reception, measurement and so on using the transmitting/receiving section 220, and the transmitting/receiving antennas 230. The control section 210 generates data, control information, a sequence and so on to transmit as a signal, and may forward the generated items to the transmitting/receiving section 220.

The transmitting/receiving section 220 may include a baseband section 221, an RF section 222, and a measurement section 223. The baseband section 221 may include a transmission processing section 2211 and a reception processing section 2212. The transmitting/receiving section 220 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 220 may be structured as a transmitting/receiving section in one entity, or may be constituted with a transmitting section and a receiving section. The transmitting section may be constituted with the transmission processing section 2211, and the RF section 222. The receiving section may be constituted with the reception processing section 2212, the RF section 222, and the measurement section 223.

The transmitting/receiving antennas 230 can be constituted with antennas, for example, an array antenna, or the like described based on general understanding of the technical field to which the present disclosure pertains.

The transmitting/receiving section 220 may receive the above-described downlink channel, synchronization signal, downlink reference signal, and so on. The transmitting/receiving section 220 may transmit the above-described uplink channel, uplink reference signal, and so on.

The transmitting/receiving section 220 may form at least one of a transmit beam and a receive beam by using digital beam forming (for example, precoding), analog beam forming (for example, phase rotation), and so on.

The transmitting/receiving section 220 (transmission processing section 2211) may perform the processing of the PDCP layer, the processing of the RLC layer (for example, RLC retransmission control), the processing of the MAC layer (for example, HARQ retransmission control), and so on, for example, on data and control information and so on acquired from the control section 210, and may generate bit string to transmit.

The transmitting/receiving section 220 (transmission processing section 2211) may perform transmission processing such as channel coding (which may include error correction coding), modulation, mapping, filtering, DFT processing (as necessary), IFFT processing, precoding, digital-to-analog conversion, and so on, on the bit string to transmit, and output a baseband signal.

Note that, whether to apply DFT processing or not may be based on the configuration of the transform precoding. The transmitting/receiving section 220 (transmission processing section 2211) may perform, for a certain channel (for example, PUSCH), the DFT processing as the above-described transmission processing to transmit the channel by using a DFT-s-OFDM waveform if transform precoding is enabled, and otherwise, does not need to perform the DFT processing as the above-described transmission processing.

The transmitting/receiving section 220 (RF section 222) may perform modulation to a radio frequency band, filtering, amplification, and so on, on the baseband signal, and transmit the signal of the radio frequency band through the transmitting/receiving antennas 230.

On the other hand, the transmitting/receiving section 220 (RF section 222) may perform amplification, filtering, demodulation to a baseband signal, and so on, on the signal of the radio frequency band received by the transmitting/receiving antennas 230.

The transmitting/receiving section 220 (reception processing section 2212) may apply reception processing such as analog-digital conversion, FFT processing, IDFT processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 220 (measurement section 223) may perform the measurement related to the received signal. For example, the measurement section 223 may perform RRM measurement, CSI measurement, and so on, based on the received signal. The measurement section 223 may measure a received power (for example, RSRP), a received quality (for example, RSRQ, SINR, SNR), a signal strength (for example, RSSI), channel information (for example, CSI), and so on. The measurement results may be output to the control section 210.

Note that the measurement section 223 may derive channel measurement for CSI computation, based on a channel measurement resource. The channel measurement resource may be, for example, a non-zero power (NZP) CSI-RS resource. The measurement section 223 may derive interference measurement for CSI computation, based on an interference measurement resource. The interference measurement resource may be at least one of an NZP CSI-RS resource for interference measurement, a CSI-interference measurement (IM) resource, and the like. Note that the CSI-IM may be referred to as CSI-interference management (IM), and may be interpreted as a zero power (ZP) CSI-RS, and vice versa. Note that, in the present disclosure, CSI-RS, NZP CSI-RS, ZP CSI-RS, CSI-IM, CSI-SSB, and the like may be interchangeably interpreted.

Note that the transmitting section and the receiving section of the user terminal 20 in the present disclosure may be constituted with at least one of the transmitting/receiving section 220 and the transmitting/receiving antennas 230.

Note that the transmitting/receiving section 220 may transmit a physical uplink shared channel (PUSCH) by using simultaneous uplink (UL) transmission from multi-panel.

The transmitting/receiving section 220 may, when simultaneous uplink (UL) transmission from multi-panel is supported, transmit a Medium Access Control Control Element (MAC CE) including a power headroom (PHR) per serving cell or per panel.

The control section 210 may control triggering of a power headroom (PHR) based on the PUSCH transmission, based on a specific condition. The specific condition relates to a prohibit timer for the PHR or maximum permitted exposure (MPE). The specific condition relates to a change in a path loss or power management maximum power reduction (PMPR) of a corresponding reference signal. The control section 210 may control triggering of the PHR for each serving cell or each panel.

The control section 210 may control transmission of the MAC CE, based on a specific condition. The MAC CE may include at least one of a field related to maximum power or a field indicating an actual PHR and a virtual PHR. The specific condition may be based on presence or absence of a UL resource associated with a corresponding panel. The control section 210 may judge, based on presence or absence of a UL resource associated with a corresponding panel, a panel to which the MAC CE is transmitted.

### (Hardware Structure)

Note that the block diagrams that have been used to describe the above embodiments show blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate apparatuses (for example, via wire, wireless, or the like) and using these apparatuses. The functional blocks may be implemented by combining software into the apparatus described above or the plurality of apparatuses described above.

Here, functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but functions are by no means limited to these. For example, a functional block (component) to implement a function of transmission may be referred to as a “transmitting section (transmitting unit)”, a “transmitter”, or the like. The method for implementing each component is not particularly limited as described above.

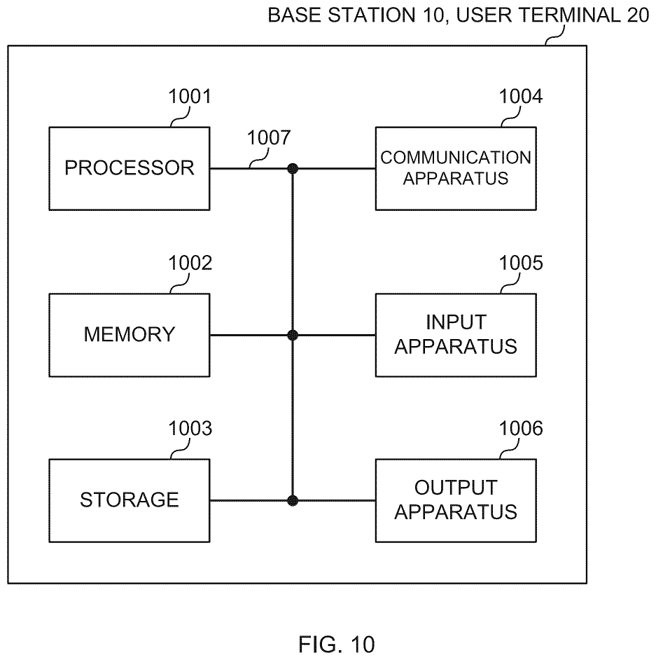

For example, a base station, a user terminal, and so on according to one embodiment of the present disclosure may function as a computer that executes the processes of the radio communication method of the present disclosure. FIG. 10 is a diagram to show an example of a hardware structure of the base station and the user terminal according to one embodiment. Physically, the above-described base station 10 and user terminal 20 may each be formed as a computer apparatus that includes a processor 1001, a memory 1002, a storage 1003, a communication apparatus 1004, an input apparatus 1005, an output apparatus 1006, a bus 1007, and so on.

Note that in the present disclosure, the words such as an apparatus, a circuit, a device, a section, a unit, and so on can be interchangeably used. The hardware structure of the base station 10 and the user terminal 20 may be configured to include one or more of apparatuses shown in the drawings, or may be configured not to include part of apparatuses.

For example, although one processor 1001 is shown in the drawings, a plurality of processors may be provided. Furthermore, processes may be implemented with one processor or may be implemented at the same time, in sequence, or in different manners with two or more processors. Note that the processor 1001 may be implemented with one or more chips.

Each function of the base station 10 and the user terminal 20 is implemented, for example, by allowing certain software (programs) to be read on hardware such as the processor 1001 and the memory 1002, and by allowing the processor 1001 to perform calculations to control communication via the communication apparatus 1004 and control at least one of reading and writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on. For example, at least a part of the control section 110 (210), the transmitting/receiving section 120 (220), and so on may be implemented by the processor 1001.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least a part of the operations explained in the above-described embodiments are used. For example, the control section 110 (210) may be implemented by control programs that are stored in the memory 1002 and that operate on the processor 1001, and other functional blocks may be implemented likewise.

The memory 1002 is a computer-readable recording medium, and may be constituted with, for example, at least one of a Read Only Memory (ROM), an Erasable Programmable ROM (EPROM), an Electrically EPROM (EEPROM), a Random Access Memory (RAM), and other appropriate storage media. The memory 1002 may be referred to as a “register”, a “cache”, a “main memory (primary storage apparatus)” and so on. The memory 1002 can store executable programs (program codes), software modules, and the like for implementing the radio communication method according to one embodiment of the present disclosure.

The storage 1003 is a computer-readable recording medium, and may be constituted with, for example, at least one of a flexible disk, a floppy (registered trademark) disk, a magneto-optical disk (for example, a compact disc (Compact Disc ROM (CD-ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. The storage 1003 may be referred to as “auxiliary storage apparatus”.

The communication apparatus 1004 is hardware (transmitting/receiving device) for allowing inter-computer communication via at least one of wired and wireless networks, and may be referred to as, for example, a “network device”, a “network controller”, a “network card”, a “communication module”, and so on. The communication apparatus 1004 may be configured to include a high frequency switch, a duplexer, a filter, a frequency synthesizer, and so on in order to realize, for example, at least one of frequency division duplex (FDD) and time division duplex (TDD). For example, the transmitting/receiving section 120 (220), the transmitting/receiving antenna 130 (230), and so on may be implemented by the communication apparatus 1004. In the transmitting/receiving section 120 (220), the transmitting section 120a (220a) and the receiving section 120b (220b) can be implemented while being separated physically or logically.

The input apparatus 1005 is an input device that receives input from the outside (for example, a keyboard, a mouse, a microphone, a switch, a button, a sensor or the like). The output apparatus 1006 is an output device that allows sending output to the outside (for example, a display, a speaker, a Light Emitting Diode (LED) lamp or the like). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between apparatuses.

Also, the base station 10 and the user terminal 20 may be structured to include hardware such as a microprocessor, a Digital Signal Processor (DSP), an Application Specific Integrated Circuit (ASIC), a Programmable Logic Device (PLD), a Field Programmable Gate Array (FPGA), and so on, and a part or all of the functional blocks may be implemented by the hardware. For example, the processor 1001 may be implemented with at least one of these pieces of hardware.

### (Variations)

It should be noted that a term used in the present disclosure and a term required for understanding of the present disclosure may be replaced by a term having the same or similar meaning. For example, a channel, a symbol, and a signal (or signaling) may be interchangeably used. Further, a signal may be a message. A reference signal may be abbreviated as an RS, and may be referred to as a pilot, a pilot signal or the like, depending on which standard applies. Furthermore, a component carrier (CC) may be referred to as a cell, a frequency carrier, a carrier frequency and so on.

A radio frame may be constituted of one or a plurality of periods (frames) in the time domain. Each of one or a plurality of periods (frames) constituting a radio frame may be referred to as a “subframe”. Furthermore, a subframe may be constituted of one or a plurality of slots in the time domain. A subframe may be a fixed time length (for example, 1 ms) independent of numerology.

Here, numerology may be a communication parameter applied to at least one of transmission and reception of a certain signal or channel. For example, numerology may indicate at least one of a subcarrier spacing (SCS), a bandwidth, a symbol length, a cyclic prefix length, a transmission time interval (TTI), the number of symbols per TTI, a radio frame structure, a specific filter processing performed by a transceiver in the frequency domain, a specific windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot”. A mini-slot may be constituted of symbols in number less than the slot. A PDSCH (or PUSCH) transmitted in a time unit larger than a mini-slot may be referred to as “PDSCH (PUSCH) mapping type A”. A PDSCH (or PUSCH) transmitted using a mini-slot may be referred to as “PDSCH (PUSCH) mapping type B”.

A radio frame, a subframe, a slot, a mini-slot, and a symbol all express time units in signal communication. A radio frame, a subframe, a slot, a mini-slot, and a symbol may each be called by other applicable terms. Note that time units such as a frame, a subframe, a slot, mini-slot, and a symbol in the present disclosure may be interchangeably used.

For example, one subframe may be referred to as a “TTI”, a plurality of consecutive subframes may be referred to as a “TTI”, or one slot or one mini-slot may be referred to as a “TTI”. In other words, at least one of a subframe and a TTI may be a subframe (1 ms) in existing LTE, may be a period shorter than 1 ms (for example, 1 to 13 symbols), or may be a period longer than 1 ms. Note that a unit expressing TTI may be referred to as a “slot”, a “mini-slot”, or the like, instead of a “subframe”.

Here, a TTI refers to the minimum time unit of scheduling in radio communication, for example. For example, in LTE systems, a base station performs, for user terminals, scheduling of allocating of radio resources (such as a frequency bandwidth and transmit power that are available for each user terminal) in TTI units. Note that the definition of TTIs is not limited to this.

The TTI may be a transmission time unit for channel-encoded data packets (transport blocks), code blocks, codewords, or the like, or may be a unit of processing in scheduling, link adaptation, or the like. Note that, when a TTI is given, a time interval (for example, the number of symbols) to which transport blocks, code blocks, codewords, or the like are actually mapped may be shorter than the TTI.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI”, a “normal subframe”, a “long subframe”, a “slot” and so on. A TTI that is shorter than a normal TTI may be referred to as a “shortened TTI”, a “short TTI”, a “partial or fractional TTI”, a “shortened subframe”, a “short subframe”, a “mini-slot”, a “sub-slot”, a “slot” and so on.

Note that a long TTI (for example, a normal TTI, a subframe, and so on) may be interpreted as a TTI having a time length exceeding 1 ms, and a short TTI (for example, a shortened TTI and so on) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

Also, an RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB))”, a “sub-carrier group (SCG)”, a “resource element group (REG)”, a “PRB pair”, an “RB pair” and so on.

Furthermore, a resource block may be constituted of one or a plurality of resource elements (REs). For example, one RE may correspond to a radio resource field of one subcarrier and one symbol.

A bandwidth part (BWP) (which may be referred to as a “fractional bandwidth”, and so on) may represent a subset of contiguous common resource blocks (common RBs) for certain numerology in a certain carrier. Here, a common RB may be specified by an index of the RB based on the common reference point of the carrier. A PRB may be defined by a certain BWP and may be numbered in the BWP.

The BWP may include a UL BWP (BWP for UL) and a DL BWP (BWP for DL). One or a plurality of BWPs may be configured in one carrier for a UE.

At least one of configured BWPs may be active, and a UE may not need to assume to transmit/receive a certain signal/channel outside the active BWP(s). Note that a “cell”, a “carrier”, and so on in the present disclosure may be used interchangeably with a “BWP”

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

Further, the information, parameters, and so on described in the present disclosure may be expressed using absolute values or relative values with respect to certain values, or may be expressed using another corresponding information. For example, a radio resource may be specified by a certain index.

The names used for parameters and so on in the present disclosure are in no respect used as limitations. Furthermore, mathematical expressions that use these parameters, and so on may be different from those explicitly disclosed in the present disclosure. Since various channels (PUCCH, PDCCH, and so on) and information elements may be identified by any suitable names, the various names allocated to these various channels and information elements are in no respect used as limitations.

The information, signals, and so on described in the present disclosure may be represented by using any of a variety of different technologies. For example, data, an instruction, a command, information, a signal, a bit, a symbol, a chip, and so on, described throughout the description of the present application, may be represented by a voltage, an electric current, electromagnetic waves, magnetic fields, a magnetic particle, optical fields, a photon, or any combination thereof.

Also, information, signals, and so on can be output at least one of from a higher layer to a lower layer and from a lower layer to a higher layer. Information, signals, and so on may be input and/or output via a plurality of network nodes.

The information, signals, and so on that are input and/or output may be stored in a specific location (for example, a memory) or may be managed by using a management table. The information, signals, and so on to be input and/or output can be overwritten, updated, or added. The information, signals, and so on that has been output may be deleted. The information, signals, and so on that has been input may be transmitted to another apparatus.

Notification of information is by no means limited to the aspects/embodiments described in the present disclosure, and other methods may be used as well. For example, notification of information in the present disclosure may be implemented by using physical layer signaling (for example, downlink control information (DCI), uplink control information (UCI)), higher layer signaling (for example, Radio Resource Control (RRC) signaling, broadcast information (master information block (MIB), system information block (SIB), and so on), Medium Access Control (MAC) signaling and so on), and other signals or combinations of these.

Note that physical layer signaling may be referred to as “Layer 1/Layer 2 (L1/L2) control information (L1/L2 control signals)”, “L1 control information (L1 control signal)”, and so on. Also, RRC signaling may be referred to as an “RRC message”, and can be, for example, an RRC connection setup message, an RRC connection reconfiguration message, and so on. Also, MAC signaling may be notified using, for example, MAC control elements (MAC CEs).

Also, notification of certain information (for example, notification of “X”) does not necessarily have to be performed explicitly, and can be performed implicitly (by, for example, not reporting this certain information or reporting another piece of information).

A decision may be realized by a value (0 or 1) represented by one bit, by a boolean value (true or false), or by comparison of numerical values (e.g., comparison with a certain value).

Software, irrespective of whether referred to as “software”, “firmware”, “middleware”, “microcode”, or “hardware description language”, or called by other terms, should be interpreted broadly to mean instructions, instruction sets, codes, code segments, program codes, programs, subprograms, software modules, applications, software applications, software packages, routines, subroutines, objects, executable files, execution threads, procedures, functions, and the like.

Also, software, instructions, information, and the like may be transmitted and received via a transmission medium. For example, when software is transmitted from a website, a server, or other remote sources by using at least one of wired technologies (coaxial cable, fiber optic cable, twisted-pair cable, digital subscriber line (DSL), and so on) and wireless technologies (infrared radiation, microwaves, and so on), at least one of these wired technologies and wireless technologies is also included in the definition of the transmission medium.

The terms “system” and “network” used in the present disclosure may be used interchangeably. The “network” may mean an apparatus (for example, a base station) included in the network.

In the present disclosure, the terms such as “precoding”, a “precoder”, a “weight (precoding weight)”, “quasi-co-location (QCL)”, a “Transmission Configuration Indication state (TCI state)”, a “spatial relation”, a “spatial domain filter”, a “transmit power”, “phase rotation”, an “antenna port”, a “layer” “the number of layers”, a “rank”, a “resource”, a “resource set”, a “beam”, a “beam width”, a “beam angular degree”, an “antenna”, an “antenna element”, a “panel”, a “UE panel”, a “transmission entity”, a “reception entity”, and so on may be used interchangeably.

Note that, in the present disclosure, the “antenna port” may be used interchangeably with an “antenna port for an arbitrary signal/channel” (for example, a demodulation reference signal (DMRS) port). In the present disclosure, the “resource” may be used interchangeably with a “resource for an arbitrary signal/channel” (e.g., a reference signal resource, an SRS resource, and the like). The resource may include time/frequency/code/space/power resource. The spatial domain transmission filter may include at least one of a spatial domain transmission filter and a spatial domain reception filter.

The group may include at least one of, for example, a spatial relationship group, a code division multiplexing (CDM) group, a reference signal (RS) group, a control resource set (CORESET) group, a PUCCH group, an antenna port group (for example, a DMRS port group), a layer group, a resource group, a beam group, an antenna group, a panel group, and the like.

In the present disclosure, a “beam”, an “SRS resource indicator (SRI)”, a “CORESET”, a “CORESET pool”, a “PDSCH”, a “PUSCH”, a “codeword (CW)”, a “transport block (TB)”, an “RS”, and the like may be interchangeably used.

In the present disclosure, a “TCI state”, a “downlink TCI state (DL TCI state)”, an “uplink TCI state (UL TCI state)”, a “unified TCI state”, a “common TCI state”, a “joint TCI state”, and the like may be used interchangeably.

In the present disclosure, “QCL”, “QCL assumption”, “QCL relationship”, “QCL type information”, “QCL property/properties”, “specific QCL type (e.g., type A, type D) property”, “specific QCL type (e.g., type A, type D)”, and the like may be used interchangeably.

In the present disclosure, an “index”, an “identifier (ID)”, an “indicator”, “indication”, a “resource ID”, and the like may be used interchangeably. In the present disclosure, a sequence, a list, a set, a group, a cluster, a subset, and the like may be used interchangeably.

A spatial relation information identifier (ID) (TCI state ID) and spatial relation information (TCI state) may be interchangeably used. “Spatial relation information (TCI state)” may be used interchangeably with “a set of spatial relation information (TCI state)”, “one or a plurality of spatial relation information”, and the like. The TCI state and the TCI may be used interchangeably. The spatial relation information and the spatial relation may be used interchangeably.

In the present disclosure, the terms such as a “base station (BS)”, a “radio base station”, a “fixed station,” a “NodeB”, an “eNB (eNodeB)”, a “gNB (gNodeB)”, an “access point”, a “transmission point (TP)”, a “reception point (RP)”, a “transmission/reception point (TRP)”, a “panel”, a “cell”, a “sector”, a “cell group”, a “carrier”, a “component carrier”, and so on can be used interchangeably. The base station may be referred to as the terms such as a “macro cell”, a “small cell”, a “femto cell”, a “pico cell”, and so on.

A base station can accommodate one or a plurality of (for example, three) cells. When a base station accommodates a plurality of cells, the entire coverage area of the base station can be partitioned into multiple smaller areas, and each smaller area can provide communication services through base station subsystems (for example, indoor small base stations (Remote Radio Heads (RRHs))). The term “cell” or “sector” refers to part of or the entire coverage area of at least one of a base station and a base station subsystem that provides communication services within this coverage.

In the present disclosure, transmitting information to the terminal by the base station may be interchangeably interpreted as instructing the terminal to perform control/operation based on the information by the base station.

In the present disclosure, the terms “mobile station (MS)”, “user terminal”, “user equipment (UE)”, and “terminal” may be used interchangeably.

A mobile station may be referred to as a “subscriber station”, “mobile unit”, “subscriber unit”, “wireless unit”, “remote unit”, “mobile device”, “wireless device”, “wireless communication device”, “remote device”, “mobile subscriber station”, “access terminal”, “mobile terminal”, “wireless terminal”, “remote terminal”, “handset”, “user agent”, “mobile client”, “client”, or some other appropriate terms in some cases.

At least one of a base station and a mobile station may be referred to as a “transmitting apparatus”, a “receiving apparatus”, a “radio communication apparatus” or the like. Note that at least one of a base station and a mobile station may be a device mounted on a moving object or a moving object itself, and so on.

The moving object is a movable object with any moving speed, and naturally, it also includes a moving object stopped. Examples of the moving object include a vehicle, a transport vehicle, an automobile, a motorcycle, a bicycle, a connected car, a loading shovel, a bulldozer, a wheel loader, a dump truck, a fork lift, a train, a bus, a trolley, a rickshaw, a ship and other watercraft, an airplane, a rocket, a satellite, a drone, a multicopter, a quadcopter, a balloon, and an object mounted on any of these, but these are not restrictive. The moving object may be a moving object that autonomously travels based on a direction for moving.

The moving object may be a vehicle (for example, a car, an airplane, and the like), may be a moving object which moves unmanned (for example, a drone, an automatic operation car, and the like), or may be a robot (a manned type or unmanned type). Note that at least one of a base station and a mobile station also includes an apparatus which does not necessarily move during communication operation. For example, at least one of a base station and a mobile station may be an Internet of Things (IoT) device such as a sensor.

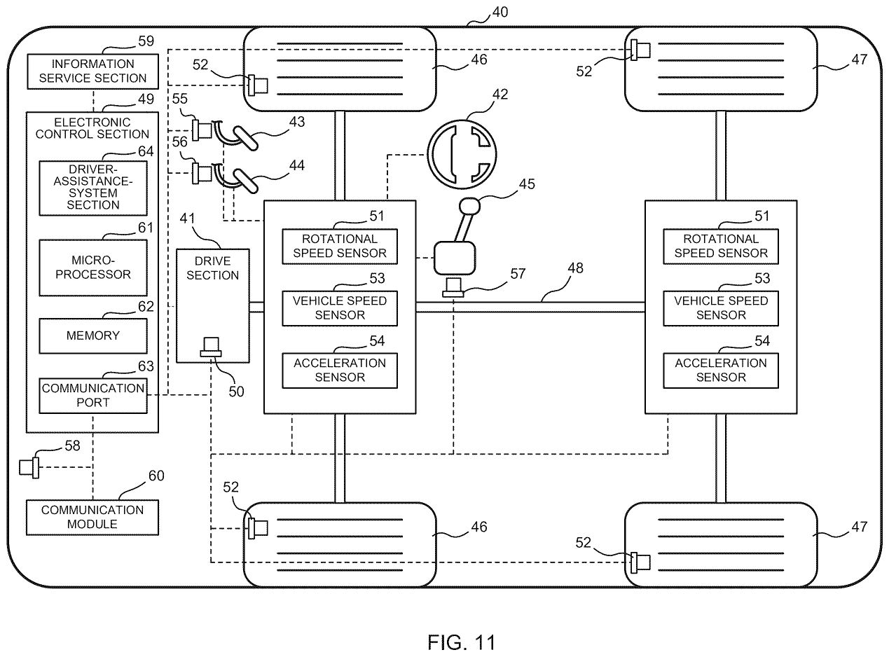

FIG. 11 is a diagram to show an example of a vehicle according to one embodiment. A vehicle 40 includes a driving section 41, a steering section 42, an accelerator pedal 43, a brake pedal 44, a shift lever 45, right and left front wheels 46, right and left rear wheels 47, an axle 48, an electronic control section 49, various sensors (including a current sensor 50, a rotational speed sensor 51, a pneumatic sensor 52, a vehicle speed sensor 53, an acceleration sensor 54, an accelerator pedal sensor 55, a brake pedal sensor 56, a shift lever sensor 57, and an object detection sensor 58), an information service section 59, and a communication module 60.

The driving section 41 includes, for example, at least one of an engine, a motor, and a hybrid of an engine and a motor. The steering section 42 includes at least a steering wheel (also referred to as a handle), and is configured to steer at least one of the front wheels 46 and the rear wheels 47, based on operation of the steering wheel operated by a user.

The electronic control section 49 includes a microprocessor 61, a memory (ROM, RAM) 62, and a communication port (for example, an input/output (IO) port) 63. The electronic control section 49 receives, as input, signals from the various sensors 50 to 58 provided in the vehicle. The electronic control section 49 may be referred to as an Electronic Control Unit (ECU).

Examples of the signals from the various sensors 50 to 58 include a current signal from the current sensor 50 for sensing current of a motor, a rotational speed signal of the front wheels 46/rear wheels 47 acquired by the rotational speed sensor 51, a pneumatic signal of the front wheels 46/rear wheels 47 acquired by the pneumatic sensor 52, a vehicle speed signal acquired by the vehicle speed sensor 53, an acceleration signal acquired by the acceleration sensor 54, a depressing amount signal of the accelerator pedal 43 acquired by the accelerator pedal sensor 55, a depressing amount signal of the brake pedal 44 acquired by the brake pedal sensor 56, an operation signal of the shift lever 45 acquired by the shift lever sensor 57, and a detection signal for detecting an obstruction, a vehicle, a pedestrian, and the like acquired by the object detection sensor 58.

The information service section 59 includes: various devices for providing (outputting) various pieces of information such as driving information, traffic information, and entertainment information, such as a car navigation system, an audio system, a speaker, a display, a television, and a radio; and one or more ECUs that control these devices. The information service section 59 provides various pieces of information/services (for example, multimedia information/multimedia service) to an occupant of the vehicle 40, using information acquired from an external apparatus via the communication module 60 and the like.

The information service section 59 may include an input device (for example, a keyboard, a mouse, a microphone, a switch, a button, a sensor, a touch panel, and the like) for receiving input from the outside, or may include an output device (for example, a display, a speaker, an LED lamp, a touch panel, and the like) for implementing output to the outside.

A driving assistance system section 64 includes: various devices for providing functions for preventing an accident and reducing a driver's driving load, such as a millimeter wave radar, Light Detection and Ranging (LiDAR), a camera, a positioning locator (for example, a Global Navigation Satellite System (GNSS) and the like), map information (for example, a high definition (HD) map, an autonomous vehicle (AV) map, and the like), a gyro system (for example, an inertial measurement apparatus (inertial measurement unit (IMU)), an inertial navigation apparatus (inertial navigation system (INS)), and the like), an artificial intelligence (AI) chip, and an AI processor; and one or more ECUs that control these devices. The driving assistance system section 64 transmits and receives various pieces of information via the communication module 60, and implements a driving assistance function or an autonomous driving function.

The communication module 60 can communicate with the microprocessor 61 and the constituent elements of the vehicle 40 via the communication port 63. For example, the communication module 60 transmits and receives data (information), via the communication port 63, to and from the driving section 41, the steering section 42, the accelerator pedal 43, the brake pedal 44, the shift lever 45, the right and left front wheels 46, the right and left rear wheels 47, the axle 48, the microprocessor 61 and the memory (ROM, RAM) 62 in the electronic control section 49, and the various sensors 50 to 58, which are included in the vehicle 40.

The communication module 60 is a communication device that can be controlled by the microprocessor 61 of the electronic control section 49 and that can perform communication with an external apparatus. For example, the communication module 60 performs transmission and reception of various pieces of information to and from the external apparatus via radio communication. The communication module 60 may be either inside or outside the electronic control section 49. The external apparatus may be, for example, the base station 10, the user terminal 20, or the like described above. The communication module 60 may be, for example, at least one of the base station 10 and the user terminal 20 described above (may function as at least one of the base station 10 and the user terminal 20).

The communication module 60 may transmit at least one of signals input from the various sensors 50 to 58 to the electronic control section 49, information obtained based on the signals, and information based on an input from the outside (a user) obtained via the information service section 59, to the external apparatus via radio communication. The electronic control section 49, the various sensors 50 to 58, the information service section 59, and the like may be referred to as input sections that receive input. For example, the PUSCH transmitted by the communication module 60 may include information based on the input.

The communication module 60 receives various pieces of information (traffic information, signal information, inter-vehicle distance information, and the like) transmitted from the external apparatus, and displays the received information on the information service section 59 included in the vehicle. The information service section 59 may be referred to as an output section that outputs information (for example, outputs information to devices, such as a display and a speaker, based on the PDSCH received by the communication module 60 (or data/information decoded from the PDSCH)).

The communication module 60 stores the various pieces of information received from the external apparatus in the memory 62 that can be used by the microprocessor 61. Based on the pieces of information stored in the memory 62, the microprocessor 61 may control the driving section 41, the steering section 42, the accelerator pedal 43, the brake pedal 44, the shift lever 45, the right and left front wheels 46, the right and left rear wheels 47, the axle 48, the various sensors 50 to 58, and the like provided in the vehicle 40.

Furthermore, the base station in the present disclosure may be interpreted as a user terminal. For example, each aspect/embodiment of the present disclosure may be applied to the structure that replaces a communication between a base station and a user terminal with a communication between a plurality of user terminals (for example, which may be referred to as “Device-to-Device (D2D)”, “Vehicle-to-Everything (V2X)”, and the like). In this case, user terminals 20 may have the functions of the base stations 10 described above. The words such as “uplink” and “downlink” may be interpreted as the words corresponding to the terminal-to-terminal communication (for example, “sidelink”). For example, an uplink channel, a downlink channel and so on may be interpreted as a sidelink channel.

Likewise, the user terminal in the present disclosure may be interpreted as a base station. In this case, the base station 10 may have the functions of the user terminal 20 described above.

Operations which have been described in the present disclosure to be performed by a base station may, in some cases, be performed by an upper node of the base station. In a network including one or a plurality of network nodes with base stations, it is clear that various operations that are performed to communicate with terminals can be performed by base stations, one or more network nodes (for example, Mobility Management Entities (MMEs), Serving-Gateways (S-GWs), and so on may be possible, but these are not limiting) other than base stations, or combinations of these.

Each aspect/embodiment described in the present disclosure may be used independently, may be used in combination, or may be switched depending on the mode of implementation. The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

The aspects/embodiments illustrated in the present disclosure may be applied to Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), 6th generation mobile communication system (6G), xth generation mobile communication system (xG (where x is, for example, an integer or a decimal)), Future Radio Access (FRA), New-Radio Access Technology (RAT), New Radio (NR), New radio access (NX), Future generation radio access (FX), Global System for Mobile communications (GSM (registered trademark)), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate radio communication methods and next-generation systems that are enhanced, modified, created, or defined based on these. A plurality of systems may be combined (for example, a combination of LTE or LTE-A and 5G, and the like) for application.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of” and “at least on the basis of”).

Reference to elements with designations such as “first”, “second”, and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

The term “deciding (determining)” as in the present disclosure herein may encompass a wide variety of actions. For example, “deciding (determining)” may be interpreted to mean making “decisions (determinations)” about judging, calculating, computing, processing, deriving, investigating, looking up, search and inquiry (for example, searching a table, a database, or some other data structures), ascertaining, and so on.

Furthermore, “deciding (determining)” may be interpreted to mean making “decisions (determinations)” about receiving (for example, receiving information), transmitting (for example, transmitting information), input, output, accessing (for example, accessing data in a memory), and so on.

In addition, “deciding (determining)” as used herein may be interpreted to mean making “decisions (determinations)” about resolving, selecting, choosing, establishing, comparing, and so on. In other words, “deciding (determining)” may be interpreted to mean making “decisions (determinations)” about some action. In the present disclosure, “decide/deciding (determine/determining)” may be interchangeably interpreted as the above-described actions.

In the present disclosure, “decide/deciding (determine/determining)” may be used interchangeably with “assume/assuming”, “expect/expecting”, “consider/considering”, and the like. Note that, in the present disclosure, “not expect to” may be used interchangeably with “expect not to”.

In the present disclosure, “expect” may be used interchangeably with “be expected”. For example, “expect(s) . . . ” (“ . . . ” may be expressed using, for example, a that-clause, a to-infinitive, or the like) may be used interchangeably with “be expected . . . ”. “Does not expect . . . ” may be used interchangeably with “be not expected . . . ”. Furthermore, “an apparatus A is not expected . . . ” may be used interchangeably with “an apparatus B other than the apparatus A does not expect . . . for the apparatus A” (for example, when the apparatus A is a UE, the apparatus B may be a base station).

“The maximum transmit power” described in the present disclosure may mean a maximum value of the transmit power, may mean the nominal maximum transmit power (the nominal UE maximum transmit power), or may mean the rated maximum transmit power (the rated UE maximum transmit power).

The terms “connected”, “coupled”, or any variation of these terms as used in the present disclosure mean any direct or indirect connections or coupling between two or more elements, and may include the presence of one or more intermediate elements between two elements that are “connected” or “coupled” to each other. The coupling or connection between the elements may be physical, logical, or a combination thereof. For example, “connection” may be interpreted as “access”.

In the present disclosure, when two elements are connected, the two elements may be considered “connected” or “coupled” to each other by using one or more electrical wires, cables and printed electrical connections, and, as some non-limiting and non-inclusive examples, by using electromagnetic energy having wavelengths in radio frequency regions, microwave regions, (both visible and invisible) optical regions, or the like.

In the present disclosure, the phrase “A and B are different” may mean that “A and B are different from each other”. It should be noted that the phrase may mean that “A and B are each different from C”. The terms “separate”, “coupled”, and so on may be interpreted similarly to “different”.

In the case where the terms “include”, “including”, and variations thereof are used in the present disclosure, these terms are intended to be comprehensive, in a manner similar to the term “comprising”. Furthermore, the term “or” used in the present disclosure is not intended to be an “exclusive or”.

For example, in the present disclosure, where an article such as “a”, “an”, and “the” is added by translation, the present disclosure may include that a noun after the article is in a plural form.

In the present disclosure, “equal to or less than”, “less than”, “equal to or more than”, “more than”, “equal to”, and the like may be used interchangeably. In the present disclosure, words such as “good”, “bad”, “large”, “small”, “high”, “low”, “early”, “late”, “wide”, “narrow”, and the like may be used interchangeably irrespective of positive degree, comparative degree, and superlative degree. In the present disclosure, expressions obtained by adding “i-th” (i is any integer) to words such as “good”, “bad”, “large”, “small”, “high”, “low”, “early”, “late”, “wide”, “narrow”, and the like may be used interchangeably irrespective of positive degree, comparative degree, and superlative degree (for example, “best” may be used interchangeably with “i-th best”, and vice versa).

In the present disclosure, “of”, “for”, “regarding”, “related to”, “associated with”, and the like may be used interchangeably.

In the present disclosure, “when A, B”, “if A, (then) B”, “B upon A”, “B in response to A”, “B based on A”, “B during/while A”, “B before A”, “B (at the same time as)/on A”, “B after A”, “B since A”, “B until A”, and the like may be used interchangeably. Note that A and B here may be replaced with appropriate expressions such as nouns, dynamic nouns, and normal sentences, as appropriate, depending on the context. The time difference between A and B may be substantially 0 (immediately after or immediately before). A time offset may be applied to the time at which A occurs. For example, “A” may be used interchangeably with “before/after the time offset at which A occurs”. The time offset (for example, one or more symbols/slots) may be defined in advance or may be specified by the UE based on the notified information.

In the present disclosure, timing, time point, time, time instance, any time unit (e.g., slot, sub-slot, symbol, subframe), period, occasion, a resource, or the like may be used interchangeably.

Now, although the invention according to the present disclosure has been described in detail above, it is apparent to a person skilled in the art that the invention according to the present disclosure is by no means limited to the embodiments described in the present disclosure. The description of the present disclosure is provided only for the purpose of explaining examples, and should by no means be construed to limit the invention according to the present disclosure in any way.

1.-6. (canceled)

7. A terminal comprising:
a transmitter that transmits capability information that supports reporting of two power headrooms (PHRs) related to multi-panel simultaneous transmission; and
a processor that triggers PHR reporting when a specified timer configured for each serving cell expires,
wherein when the multi-panel simultaneous transmission is configured for a serving cell, the processor includes the two PHRs in a medium access control control element (MAC CE).

8. The terminal according to claim 7, wherein the specified timer is a prohibit timer or a periodic timer.

9. The terminal according to claim 7, wherein the processor triggers the PHR reporting when path loss of a reference signal corresponding to a serving cell has changed more than a certain threshold.

10. A radio communication method for a terminal, comprising:
transmitting capability information that supports reporting of two power headrooms (PHRs) related to multi-panel simultaneous transmission;
triggering PHR reporting when a specified timer configured for each serving cell expires; and
when the multi-panel simultaneous transmission is configured for a serving cell, including the two PHRs in a medium access control control element (MAC CE).

11. A base station comprising:
a receiver that receives capability information that supports reporting of two power headrooms (PHRs) related to multi-panel simultaneous transmission; and
a transmitter that transmits a configuration of the multi-panel simultaneous transmission for a serving cell, and transmits configuration information regarding a specified timer configured for each serving cell, in order for a terminal to trigger PHR reporting,
wherein the receiver receives, from the terminal, a medium access control control element (MAC CE) including the two PHRs.

12. A system comprising a terminal and a base station, wherein
the terminal comprises:
a transmitter that transmits capability information that supports reporting of two power (PHRs) related to multi-panel simultaneous transmission; and
a processor that triggers PHR reporting when a specified timer configured for each serving cell expires,
wherein when the multi-panel simultaneous transmission is configured for a serving cell, the processor includes the two PHRs in a medium access control control element (MAC CE), and
the base station comprises:
a receiver that receives the capability information.
